(19) United States
(12) Patent Application Publication
(10) Pub. No.: US 2026/0251305 A1
(43) Pub. Date: Aug. 27, 2026

(54) BURNER ASSEMBLY, GAS TURBINE COMBUSTOR, AND GAS TURBINE

(71) Applicant: MITSUBISHI HEAVY INDUSTRIES, LTD., Tokyo (JP)

(72) Inventors: Zhi ZHANG, Tokyo (JP); Shinichi FUKUBA, Tokyo (JP); Keisuke MIURA, Tokyo (JP); Taku EGAWA, Tokyo (JP); Kiyoshi FUJIMOTO, Tokyo (JP); Kenta TANIGUCHI, Tokyo (JP); Tomo KAWAKAMI, Tokyo (JP); Ryuhei KANOSHIMA, Tokyo (JP); Hiroyuki TATE, Tokyo (JP)

(21) Appl. No.: 19/162,642

(22) PCT Filed: Mar. 21, 2024
(86) PCT No.: PCT/JP2024/010904

§ 371 Date: Sep. 5, 2025

(30) Foreign Application Priority Data
Mar. 29, 2023 (JP) 2023-053155

(51) Int. Cl. F23R 3/28; F02C 7/22; F23D 14/02

(52) U.S. Cl. CPC F23R 3/286; F02C 7/22; F23D 14/02

(57) ABSTRACT

In a bummer assembly according to at least one embodiment of the present disclosure, each of a plurality of burners is provided with a flow passage through which air can flow. The flow passage includes a first region, in which a fuel injection hole is formed, and a second region, which is located downstream of the first region and in which the fuel injected through the injection hole and air are mixed. The first region extends from an upstream-side end part of the flow passage to a connection position with the second region, and the injection hole is formed at a position closer to the connection position than the upstream-side end part. The first region has at least one protrusion, which protrudes radially inward of the flow path and in which the injection hole is formed, and at least one peripheral wall, which is adjacent to the at least one protrusion in the circumferential direction of the flow passage and in which the protrusion is not provided. The cross-sectional area of the flow passage is such that a second cross-sectional area within the second region is less than a first cross-sectional area within the first region.

### TECHNICAL FIELD

The present disclosure relates to a burner assembly, a gas turbine combustor, and a gas turbine.

The present application claims priority based on Japanese Patent Application No. 2023-053155 filed in Japan on Mar. 29, 2023, the contents of which are incorporated herein by reference.

### BACKGROUND ART

There is a technique for forming a large number of independent small flames via a burner assembly (cluster burner), as a technique for realizing low NOx while having flashback resistance for a fuel (for example, hydrogen) having a high risk of flashback.

In this technique, a plurality of mixing flow paths for mixing the fuel and air are disposed, and a scale of fuel mixing is reduced. In this manner, high mixing performance can be obtained without actively using a vortex flow for mixing the fuel and the air.

PTL 1 discloses a burner assembly for suppressing the flashback while achieving the low NOx. Each burner of the burner assembly includes a fuel nozzle and a mixing flow path through which the fuel and the air flow, and the fuel nozzle includes a protrusion portion protruding to an upstream side in a flow direction of the air with respect to an inlet of the mixing flow path. In addition, a fuel injection hole is formed on a side surface of the protrusion portion, and the fuel injected from the fuel injection hole flows into the inlet of the mixing flow path together with the air such that the fuel and the air are mixed.

### CITATION LIST

### Patent Literature

[PTL 1] Japanese Unexamined Patent Application Publication No. 2019-168198

### SUMMARY OF INVENTION

### Technical Problem

The burner assembly disclosed in PTL I has room for further improvement from a viewpoint of suppressing the flashback.

In view of above-described circumstances, an object of at least one embodiment of the present disclosure is to provide a burner assembly, a gas turbine combustor, and a gas turbine, which can suppress flashback.

### Solution to Problem

(1) According to at least one embodiment of the present disclosure, there is provided a burner assembly including a plurality of burners for mixing a fuel and air. In the burner assembly, each of the plurality of burners includes a flow path through which the air is configured to flow. The flow path includes a first region that is a region on an upstream side of a flow of the air and having an injection hole of the fuel, and a second region that is a downstream-side region of the first region and in which the fuel injected from the injection hole and the air are mixed. The first region extends from an upstream-side end portion of the flow path to a connection position to the second region. The first region has the injection hole formed at a position closer to the connection position than the upstream-side end portion. The first region includes at least one protrusion portion protruding inward of the flow path in a radial direction and having the injection hole, and at least one peripheral wall portion adjacent to the at least one protrusion portion in a circumferential direction of the flow path and in which the protrusion portion is not provided. In a cross-sectional area of the flow path when viewed in an extending direction of the flow path, a second cross-sectional area in the second region is smaller than a first cross-sectional area in the first region.
(2) According to at least one embodiment of the present disclosure, there is provided a gas turbine combustor including the burner assembly according to (1) above, and a combustion cylinder forming a space in which a flame is formed on a downstream side of the burner assembly.
(3) According to at least one embodiment of the present disclosure, there is provided a gas turbine including a compressor, a gas turbine combustor to which air compressed by the compressor and a fuel are supplied, and configured to generate a combustion gas by combusting the fuel, and a turbine driven by the combustion gas generated in the gas turbine combustor. The gas turbine combustor is the gas turbine combustor having a configuration of (2) above.

### Advantageous Effects of Invention

According to at least one embodiment of the present disclosure, it is possible to provide a burner assembly, a gas turbine combustor, and a gas turbine, which can suppress flashback.

### BRIEF DESCRIPTION OF DRAWINGS

FIG. 1 is a schematic configuration diagram of a gas turbine according to an embodiment.

FIG. 2 is a cross-sectional view showing a vicinity of a combustor.

FIG. 3 is a perspective view for describing a structure of the combustor.

FIG. 4 is a partial schematic perspective view showing a portion of a burner assembly according to the embodiment.

FIG. 5 is a view corresponding to a cross-sectional view taken along line V-V in FIG. 4 with regard to a portion of the burner assembly according to the embodiment.

FIG. 6 is a schematic view showing a portion of a cross section taken along line VI-VI in FIG. 5.

FIG. 7 is a partial schematic perspective view showing a portion of the burner assembly according to the embodiment, and shows a state where an introduction flow path wall is removed for description.

FIG. 8 is a schematic view when a portion of the burner assembly in the state where the introduction flow path wall is removed for description is viewed from an upstream side in a flow direction of air along a central axis line.

FIG. 9 is a schematic view showing a portion of a cross section taken along line IX-IX in FIG. 8.

FIG. 10 is a schematic view showing a portion of a cross section taken along line X-X in FIG. 8.

FIG. 11 is a view corresponding to a cross-sectional view taken along line V-V in FIG. 4 with regard to a portion of a burner assembly according to another embodiment.

FIG. 12 is a schematic view showing a portion of a cross section taken along line XII-XII in FIG. 11.

FIG. 13 is a cross-sectional view when a XIII portion surrounded by a broken line in FIG. 6 is viewed from the upstream side in the flow direction of the air.

FIG. 14 is a view corresponding to a cross-sectional view when the XIII portion surrounded by the broken line in FIG. 6 is viewed from the upstream side in the flow direction of the air, and shows another example with regard to a protrusion portion.

FIG. 15 is a view for describing dimensions of each portion of the burner assembly according to some embodiments.

FIG. 16 is a view for describing dimensions of each portion of the burner assembly according to some embodiments.

FIG. 17 is a view for describing a variation in a shape of the protrusion portion.

FIG. 18 is a cross-sectional view when a XVIII portion surrounded by a broken line in FIG. 17 is viewed from the upstream side in the flow direction of the air

FIG. 19 is a view corresponding to a cross-sectional view when the XVIII portion surrounded by the broken line in FIG. 17 is viewed from the upstream side in the flow direction of the air, and shows another example.

FIG. 20 is a view for describing a variation in the shape of the protrusion portion.

FIG. 21 is a cross-sectional view when a XXI portion surrounded by a broken line in FIG. 20 is viewed from the upstream side in the flow direction of the air.

FIG. 22 is a view for describing a modification example with regard to an introduction flow path wall and a flow path wall.

FIG. 23 is a schematic view for describing an extending direction of a fuel injection hole, and shows a cross section orthogonal to a central axis line.

FIG. 24 is a schematic view for describing the extending direction of the fuel injection hole, and shows a cross section orthogonal to the central axis line.

FIG. 25 is a view showing another example of a protrusion portion of a fuel nozzle, and is a view corresponding to the cross-sectional view taken along line XXV-XXV in FIG. 5.

FIG. 26 is a schematic view when a portion of a burner assembly according to a modification example of a first region is viewed from the upstream side in the flow direction of the air along a central axis line L.

FIG. 27 is a schematic cross-sectional view of the first region appearing in a cross section including a central axis line of a flow path.

FIG. 28 is a schematic cross-sectional view of the first region appearing in the cross section including the central axis line of the flow path.

FIG. 29 is a schematic cross-sectional view of the first region appearing in the cross section including the central axis line of the flow path.

FIG. 30A is a schematic cross-sectional view showing an A-A cross section in FIG. 26.

FIG. 30B is a schematic cross-sectional view showing a B-B cross section in FIG. 26.

FIG. 31A is a schematic cross-sectional view showing the A-A cross section in FIG. 26.

FIG. 31B is a schematic cross-sectional view showing the B-B cross section in FIG. 26.

FIG. 32A is a schematic cross-sectional view showing the A-A cross section in FIG. 26.

FIG. 32B is a schematic cross-sectional view showing the B-B cross section in FIG. 26.

FIG. 33A is a schematic cross-sectional view showing the A-A cross section in FIG. 26.

FIG. 33B is a schematic cross-sectional view showing the B-B cross section in FIG. 26.

FIG. 34A is a schematic cross-sectional view showing the A-A cross section in FIG. 26.

FIG. 34B is a schematic cross-sectional view showing the B-B cross section in FIG. 26.

FIG. 35A is a schematic cross-sectional view showing the A-A cross section in FIG. 26.

FIG. 35B is a schematic cross-sectional view showing the B-B cross section in FIG. 26.

### DESCRIPTION OF EMBODIMENTS

Hereinafter, some embodiments of the present disclosure will be described with reference to the accompanying drawings. However, dimensions, materials, shapes, and relative dispositions of components described as the embodiments or shown in the drawings are not intended to limit the scope of the present disclosure, and are merely examples for describing the present disclosure.

For example, expressions representing relative or absolute dispositions such as “in a certain direction”, “along a certain direction”, “parallel”, “orthogonal”, “center”, “concentric”, or “coaxial” not only strictly represent the dispositions, but also represent a state where the dispositions are relatively displaced with a tolerance or at an angle or a distance to such an extent that the same function can be obtained.

For example, expressions representing that things are in an equal state such as “same”, “equal”, and “homogeneous” not only strictly represent an equal state, but also represent a state where a difference exists with a tolerance or to such an extent that the same function can be obtained.

For example, expressions representing shapes such as a quadrangular shape and a cylindrical shape not only represent shapes such as a quadrangular shape and a cylindrical shape in a geometrically strict sense, but also represent shapes including an uneven portion or a chamfered portion within a range where the same effect can be obtained.

In addition, expressions of “being provided with”, “being equipped with”, “including”, or “having” one component are not exclusive expressions excluding the presence of other components.

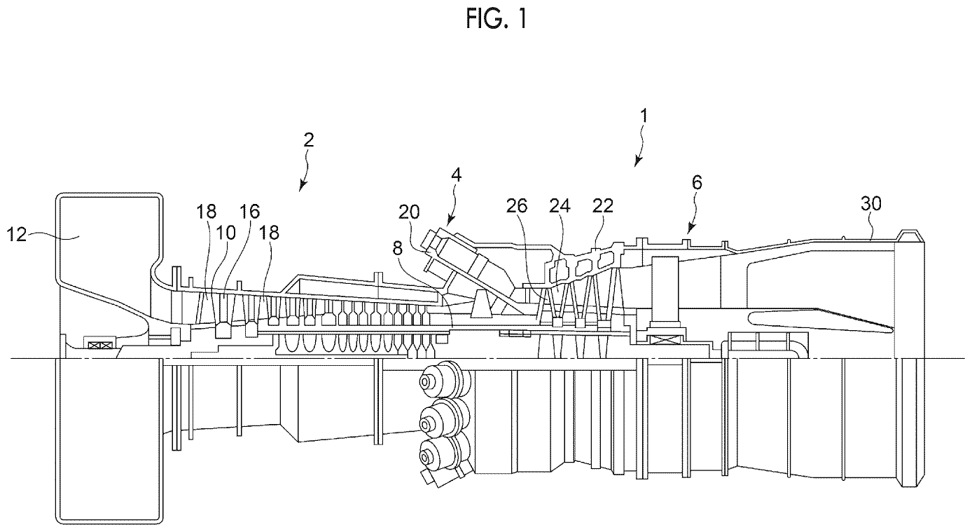

First, a gas turbine, which is an example of an application destination of a burner and a combustor according to some embodiments, will be described with reference to FIG. 1. FIG. 1 is a schematic configuration diagram of a gas turbine according to the embodiment. As shown in FIG. 1, a gas turbine 1 includes a compressor 2 for generating compressed air, a combustor 4 for generating a combustion gas using the compressed air and fuel, and a turbine 6 configured to be rotationally driven by the combustion gas. In a case of the gas turbine 1 for power generation, a generator (not shown) is connected to the turbine 6.

The compressor 2 includes a plurality of stator vanes 16 fixed to a side of a compressor casing 10, and a plurality of rotor vanes 18 embedded in a rotor 8 to be alternately disposed with respect to the stator vanes 16.

Air taken in from an air intake port 12 is fed to the compressor 2. The air passes through the plurality of stator vanes 16 and the plurality of rotor vanes 18, and is compressed to be high-temperature and high-pressure compressed air.

The fuel and the compressed air generated by the compressor 2 are supplied to the combustor 4, and the fuel is combusted in the combustor 4. In this manner, combustion gas serving as a working fluid of the turbine 6 is generated. As shown in FIG. 1, the gas turbine 1 includes a plurality of combustors 4 disposed along a circumferential direction around the rotor 8 inside a casing 20.

The turbine 6 includes a plurality of stator vanes 24 and a plurality of rotor vanes 26 which are provided in a combustion gas passage formed by a turbine casing 22. The stator vanes 24 and the rotor vanes 26 of the turbine 6 are provided on a downstream side of the combustor 4 with respect to a flow of the combustion gas.

The stator vane 24 is fixed to a side of the turbine casing 22, and a stator vane row is formed by the plurality of stator vanes 24 disposed along the circumferential direction of the rotor 8. In addition, the rotor vane 26 is embedded in the rotor 8, and a rotor vane row is formed by the plurality of rotor vanes 26 disposed along the circumferential direction of the rotor 8. The stator vane row and the rotor vane row are alternately disposed in an axial direction of the rotor 8.

In the turbine 6, the combustion gas flowing into the combustion gas passage from the combustor 4 passes through the plurality of stator vanes 24 and the plurality of rotor vanes 26 to rotationally drive the rotor 8. In this manner, a generator connected to the rotor 8 is driven to generate power. After the turbine 6 is driven, the combustion gas is discharged to an outside via an exhaust chamber 30.

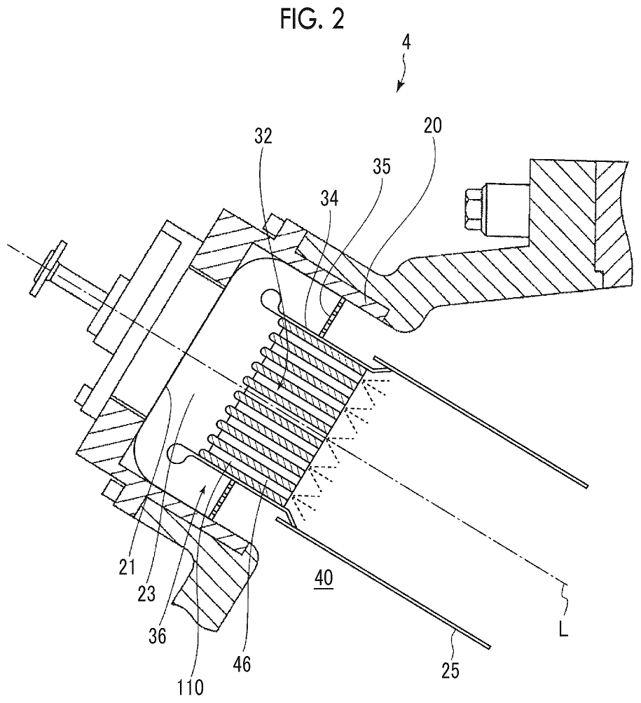

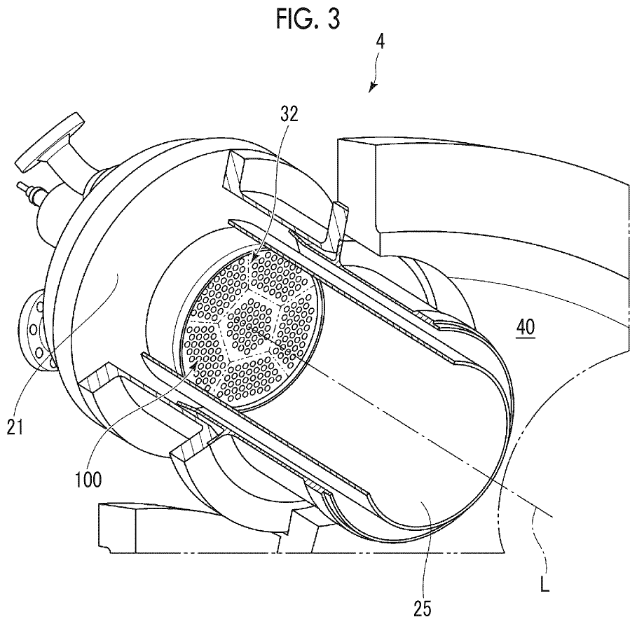

FIG. 2 is a cross-sectional view showing a vicinity of the combustor 4. FIG. 3 is a perspective view for describing a structure of the combustor 4. The combustor 4 includes a burner assembly 32, a bottomed tubular casing 20 accommodating the burner assembly 32, and a combustion cylinder 25 forming a space in which a flame is formed on a downstream side of the burner assembly 32. In FIG. 2, a one-dot chain line is a central axis line L common to each of the casing 20, the burner assembly 32, and the combustion cylinder 25. The burner assembly 32 is disposed inside the casing 20 of the combustor 4. In an exemplary embodiment shown in the drawing, the burner assembly 32 is held inside a tubular member 34 disposed inside the casing 20, and the tubular member 34 is supported by the casing 20 via a plurality of support portions 35 disposed at an interval around the central axis line L. An air flow path 36 through which the compressed air flowing into a casing 40 flows is formed between the casing 20 and an outer peripheral surface of the tubular member 34 (between the casing 20 and an outer peripheral surface of the burner assembly 32).

The compressed air flowing into the air flow path 36 from the casing 40 flows into a plurality of mixing flow paths 46 (to be described later) provided in the burner assembly 32 together with the fuel through a gap 23 in the axial direction between the burner assembly 32 and a bottom surface 21 of the casing 20. The fuel and the air which are mixed in the burner assembly 32 are ignited by an igniter (not shown), and the flame is formed in the combustion cylinder 25 to generate the combustion gas.

In some embodiments, the burner assembly 32 includes a plurality of burners 42 for mixing the fuel and the air as described later. Each of the burners 42 includes a flow path 100 (to be described later) through which the fuel and the air flow. In some embodiments, for example, as shown in FIG. 3, when the burner assembly 32 is viewed from the downstream side along the central axis line L, a plurality of flow paths 100 are disposed in each of a pentagonal region depicted by a dashed double-dotted line around the central axis line L and five regions aligned in the circumferential direction outside the pentagonal region to correspond to each side of the pentagon.

A disposition pattern of each flow path 100 shown in FIG. 3 is an example, and the disposition pattern of each flow path 100 is not necessarily the same as that shown in FIG. 3.

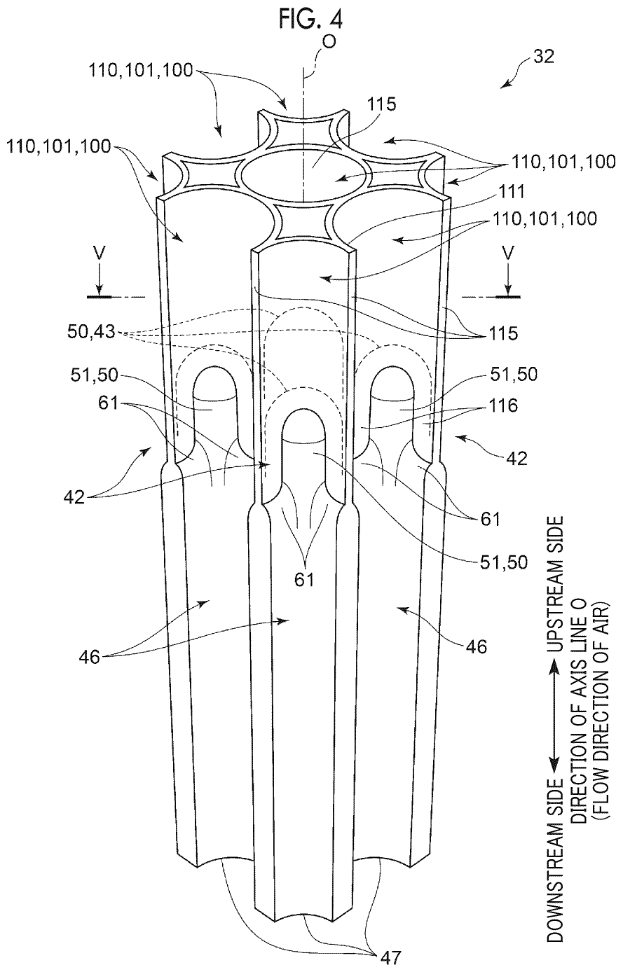

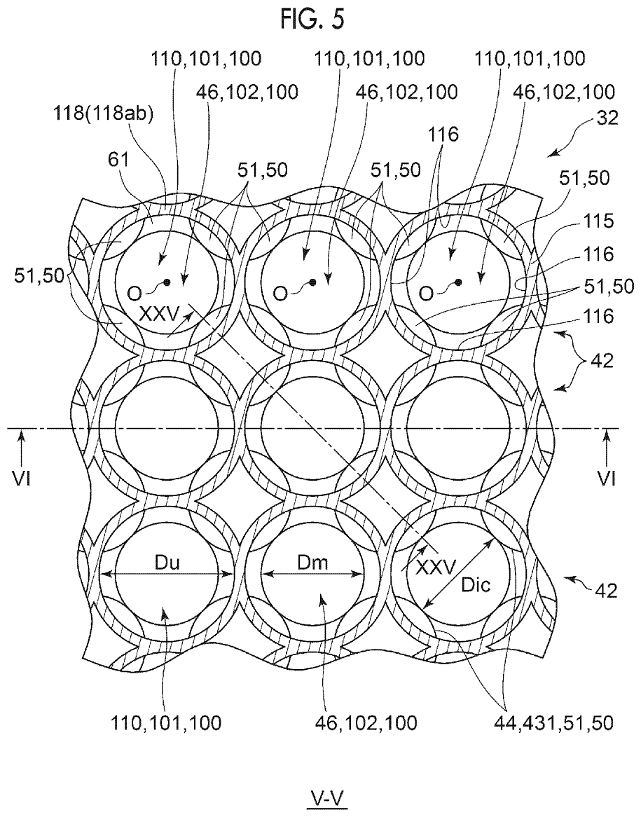

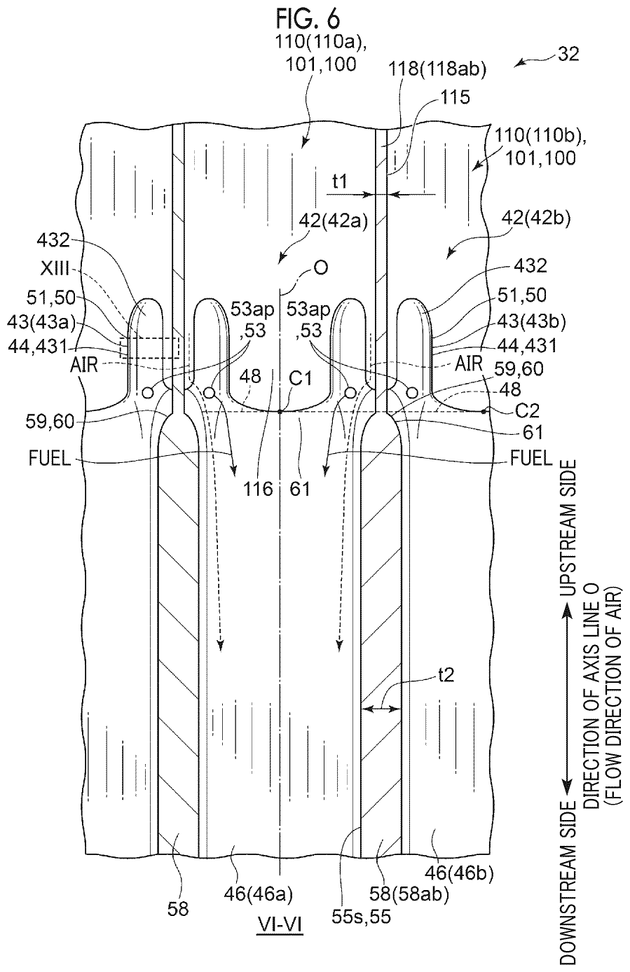

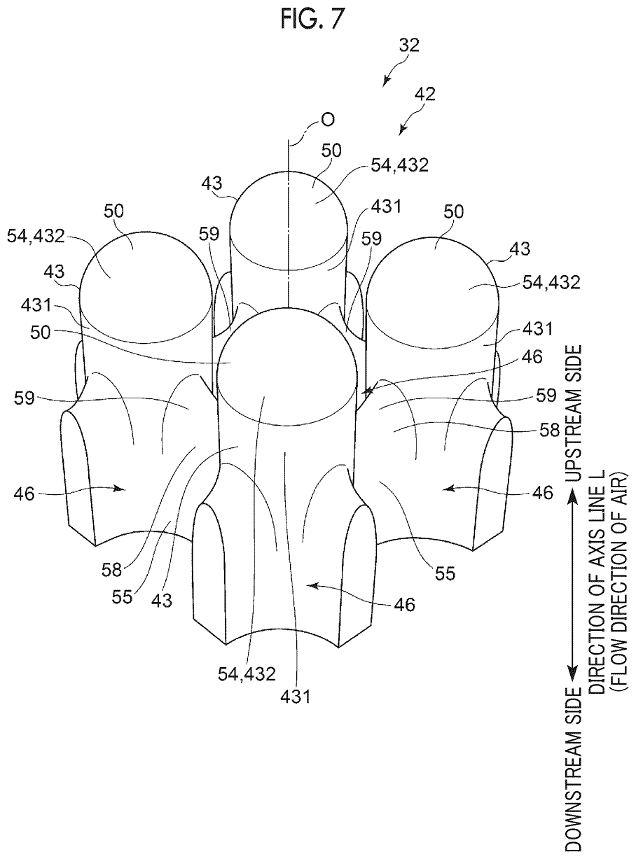

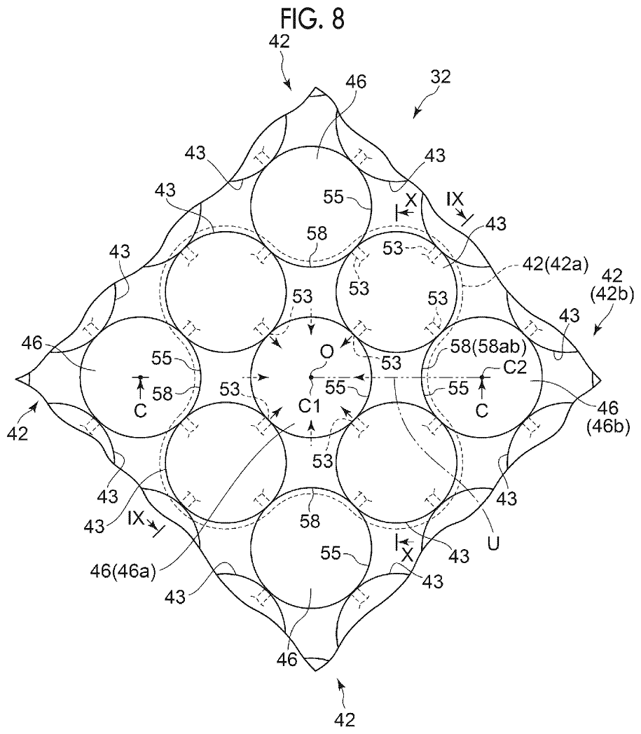

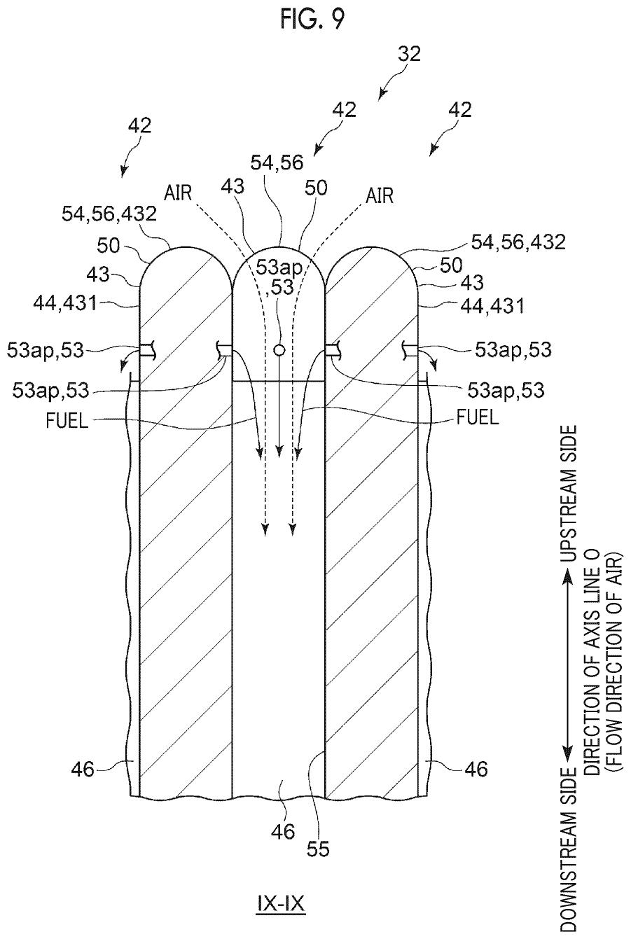

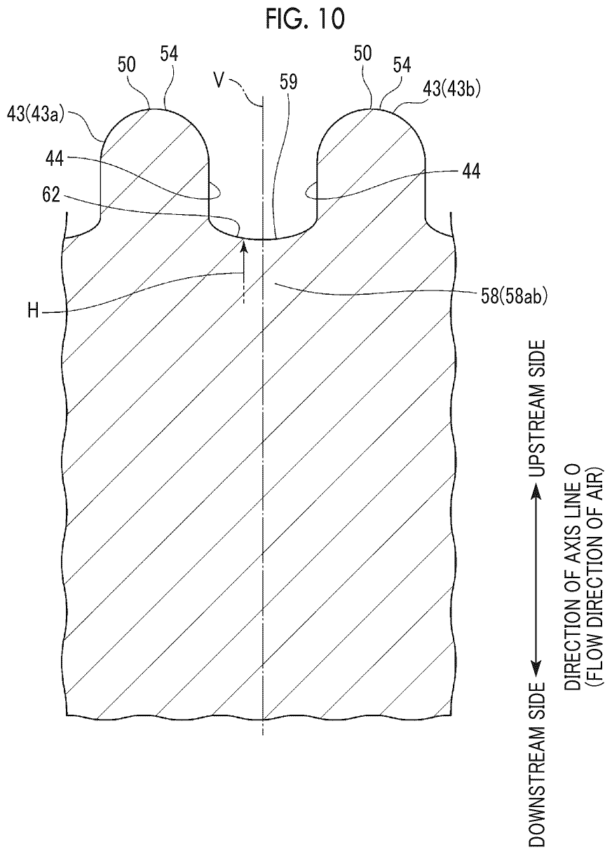

FIG. 4 is a partial schematic perspective view showing a portion of the burner assembly 32 according to the embodiment. FIG. 5 is a view corresponding to a cross-sectional view taken along line V-V in FIG. 4 with regard to a portion of the burner assembly 32 according to the embodiment. FIG. 6 is a schematic view showing a portion of a cross section taken along line VI-VI in FIG. 5. FIG. 7 is a partial schematic perspective view showing a portion of the burner assembly 32 according to the embodiment, and shows a state where an introduction flow path wall 115 (to be described later) is removed for description. FIG. 8 is a schematic view when a portion of the burner assembly 32 in the state where the introduction flow path wall 115 is removed for description is viewed from the upstream side in the flow direction of the air along the central axis line L. FIG. 9 is a schematic view showing a portion of a cross section taken along line IX-IX in FIG. 8. FIG. 10 is a schematic view showing a portion of the cross section taken along line X-X in FIG. 8.

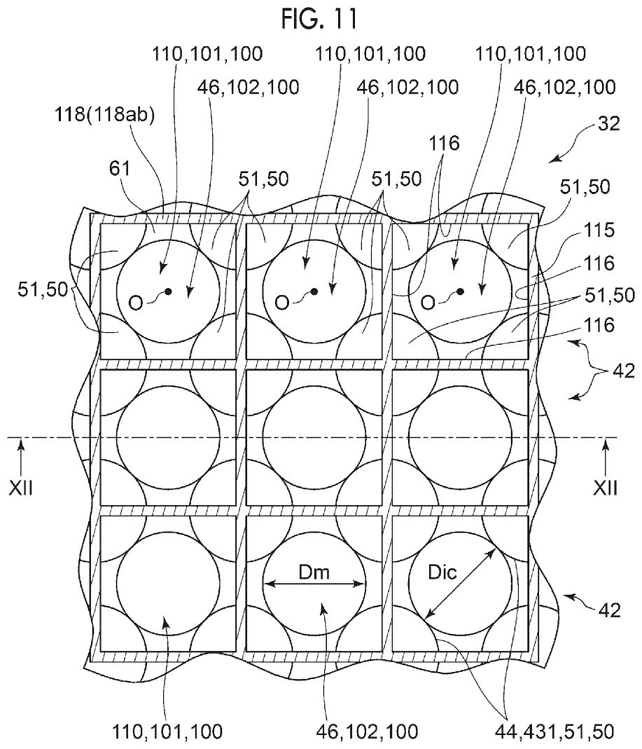

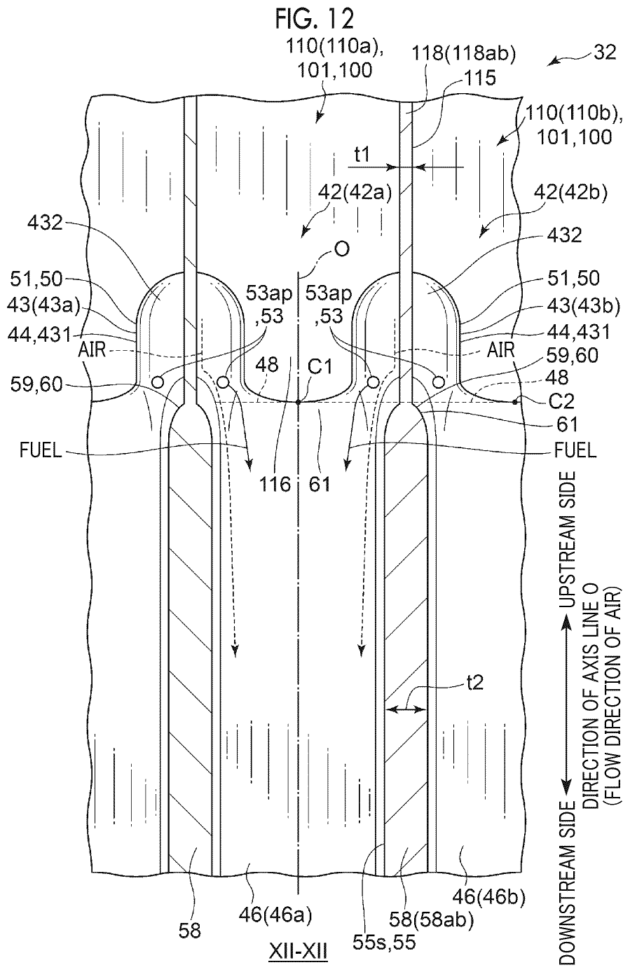

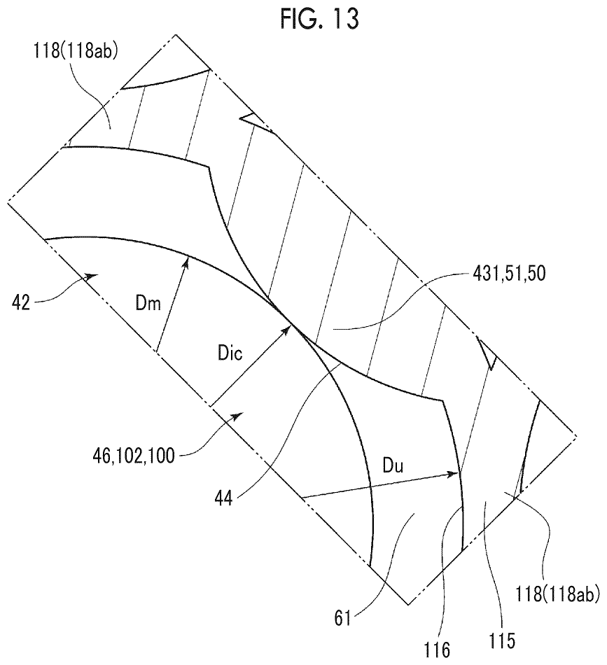

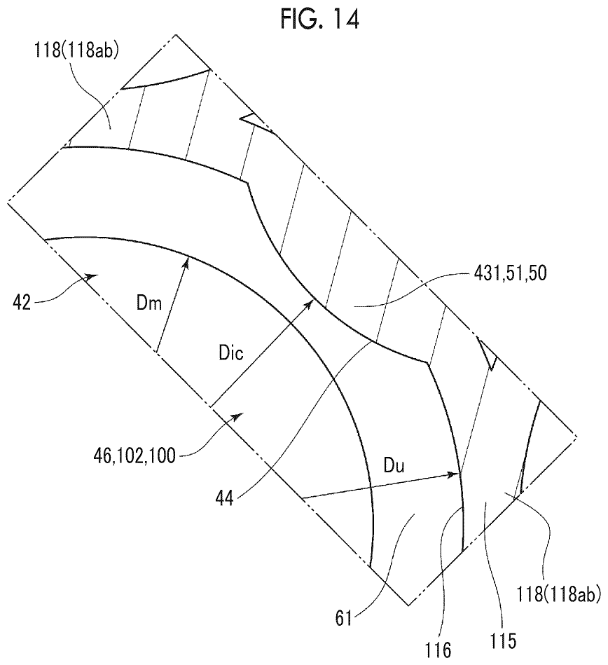

FIG. 11 is a view corresponding to the cross-sectional view taken along line V-V in FIG. 4 with regard to a portion of the burner assembly 32 according to another embodiment. FIG. 12 is a schematic view showing a portion of a cross section taken along line XII-XII in FIG. 11. FIG. 13 is a cross-sectional view when a XIII portion surrounded by a broken line in FIG. 6 is viewed from the upstream side in the flow direction of the air. FIG. 14 is a view corresponding to a cross-sectional view when the XIII portion surrounded by the broken line in FIG. 6 is viewed from the upstream side in the flow direction of the air, and shows another example of a protrusion portion 51 (to be described later).

For example, as shown in FIGS. 4 to 9, 11, and 12, the burner assembly 32 includes the plurality of burners 42 for mixing the fuel and the air.

Each of the burners 42 according some embodiments includes an introduction flow path 110 for introducing the compressed air for combustion from the casing 40 (refer to FIGS. 1 and 2) to each of the burners 42, a plurality of fuel nozzles 43 for injecting the fuel, and a mixing flow path 46 into which the fuel injected from the plurality of fuel nozzles 43 and the compressed air supplied from the introduction flow path 110 flow. In the exemplary form shown in the drawing, as in a first burner 42a (refer to FIG. 8) (to be described later), each of the burners 42 includes one introduction flow path 110, one mixing flow path 46, and four fuel nozzles 43 disposed around one mixing flow path 46, and the fuel is injected into one mixing flow path 46 from the four fuel nozzles 43 around one mixing flow path 46. In other words, four mixing flow paths 46 are disposed around one fuel nozzle 43, and one fuel nozzle 43 injects the fuel into the four mixing flow paths 46.

In each of the burners 42 according to some embodiments, the flow path 100 through which the fuel and the air flow includes the introduction flow path 110 and the mixing flow path 46 connected to the downstream side of the introduction flow path 110. The introduction flow path 110 and the mixing flow path 46 are connected in an inlet 48 (for example, refer to FIGS. 6 and 12) (to be described later) of the mixing flow path 46, which is a connection position between the introduction flow path 110 and the mixing flow path 46.

The introduction flow path 110 is a first region 101 in the flow path 100, and the mixing flow path 46 is a second region 102 in the flow path 100.

Each of the flow paths 100 is configured as through-holes extending parallel to each other, and a central axis line O of each of the flow paths 100 extends in a direction along the central axis line L of the casing 20. In an exemplary form shown in the drawing, the central axis line O of each of the flow paths 100 and the central axis line L of the casing 20 are parallel to each other.

In the following description, in describing each portion of the flow path 100, the radial direction and the circumferential direction around the central axis line O may be simply referred to as the radial direction and the circumferential direction. An extending direction of the flow path 100 coincides with an extending direction of the central axis line O.

### Introduction Flow Path Wall 115

For example, the introduction flow path wall 115 forming the introduction flow path 110 shown in FIGS. 4 to 6 is formed in a circular tubular shape such that the introduction flow path 110 having a circular cross section is defined inward, and functions as a rectifying portion for rectifying air flowing into the mixing flow path 46.

In addition, for example, the introduction flow path wall 115 forming the introduction flow path 110 shown in FIGS. 11 and 12 is formed in a rectangular tubular shape such that the introduction flow path 110 having a rectangular cross section is defined inward, and functions as a rectifying portion for rectifying the air flowing into the mixing flow path 46.

Hereinafter, for example, as shown in FIG. 6, any two burners 42 in which the mixing flow paths 46 are closest to each other, in the plurality of burners 42, will be referred to as a first burner 42a and a second burner 42b for convenience. Similarly, the flow path 100 of the first burner 42a may be referred to as a first flow path 100a, and the flow path 100 of the second burner 42b may be referred to as a second flow path 100b. The second flow path 100b is a flow path 100 closest to the first flow path 100a.

As shown in FIGS. 4 to 6, 11, and 12, the introduction flow path wall 115 forming the introduction flow path 110 (110a) of the first burner 42a and the introduction flow path wall 115 forming the introduction flow path 110 (110b) of the second burner 42b share a bulkhead portion 118 (118ab) that divides the introduction flow path 110a of the first burner 42a and the introduction flow path 110b of the second burner 42b. In an exemplary form shown in FIGS. 4 to 6, 11, and 12, the introduction flow path wall 115 of the introduction flow path 110 shares the bulkhead portion 118 with each of the introduction flow path walls 115 of the plurality of introduction flow paths 110 (four introduction flow paths 110 in a form shown in the drawing) around the introduction flow path 110.

In addition, as shown in FIGS. 6 and 12, a thickness t1 of the bulkhead portion 118 (118ab) in a VI-VI cross section and a XII-XII cross section of the burner assembly 32 is constant in the direction along the central axis line O of the first burner 42a.

### Fuel Nozzle 43

For example, as shown in FIG. 9, each of the fuel nozzles 43 includes a protrusion portion 50 protruding to the downstream-side region inside the introduction flow path 110, that is, to the upstream side of the inlet 48 (for example, refer to FIG. 6) of the mixing flow path 46 in the flow direction of the air. In addition, each of the fuel nozzles 43 includes a plurality of fuel injection holes 53 formed on a side surface 44 of the protrusion portion 50. In an exemplary form shown in FIG. 8, on the side surface 44 of the protrusion portion 50, four fuel injection holes 53 are formed at positions corresponding to four flow paths 100 (mixing flow paths 46) around the protrusion portion 50. Each of the fuel injection holes 53 may extend in a direction orthogonal to the central axis line O to inject the fuel toward the central axis line O of the flow path 100 as will be described later, or may extend in an oblique direction with respect to the direction orthogonal to the central axis line O.

As shown in FIG. 9, each of the fuel nozzles 43 includes a base end portion 431 having the side surface 44 formed to be parallel to the central axis line O, and a tip portion 432 formed from the base end portion 431 toward the upstream side in the flow direction of the air.

As shown in FIGS. 4 to 6, 11, and 12, in each of the protrusion portions 50, a portion of the base end portion 431 and the tip portion 432 protrudes inward in the radial direction inside the introduction flow path 110 in the downstream-side region inside the introduction flow path 110. Each of the protrusion portions 50 shown in FIGS. 4 to 6, 11, and 12 has the same shape as a rotating body formed around an axis line parallel to the central axis line O.

In examples shown in FIGS. 4 to 6, 11, and 12, when viewed along the central axis line O, a portion of the base end portion 431 and the tip portion 432 of each of the four protrusion portions 50 disposed to surround a periphery of one introduction flow path 110 protrudes inward in the radial direction of the introduction flow path 110 at a position in a circumferential direction at every 90 degrees around the central axis line O.

When each of the protrusion portions 50 is focused, in the examples shown in FIGS. 4 to 6, 11, and 12, each of the protrusion portions 50 protrudes inward of each of the four introduction flow paths 110 disposed to surround the periphery of one protrusion portion 50.

In the examples shown in FIGS. 4 to 6, 11, and 12, among the four protrusion portions 50 disposed to surround the periphery of one introduction flow path 110, the protrusion portions 51, which are inward protrusion portions of the introduction flow path 110 of the two protrusion portions 50 adjacent to each other in the circumferential direction around the central axis line O, are separated in the circumferential direction. A peripheral wall portion 116 in which the protrusion portion 51 is not provided is provided between the two protrusion portions 51 adjacent to each other in the circumferential direction. That is, in the examples shown in FIGS. 4 to 6, 11, and 12, the protrusion portion 51 and the peripheral wall portion 116 are alternately disposed in the circumferential direction at an axial position where the protrusion portion 51 is provided.

For example, as shown in FIG. 9, a top surface 54 of the protrusion portion 50 (end surface of the protrusion portion 50 in the direction of the axis line O, that is, tip of the protrusion portion 50) includes a convex curved surface 56. In the exemplary form shown in the drawing, the entire top surface 54 of the protrusion portion 50 is formed by the convex curved surface 56 that is smoothly curved. For example, the top surface 54 of the protrusion portion 50 may be formed in a streamline shape. A variation in a shape of the protrusion portion 50 will be described later.

In the burner assembly 32 according to some embodiments, in a cross section taken along the extending direction of the central axis line O, the protrusion portion 51 includes a base end portion 431 extending in a linear shape along the extending direction of the central axis line O, and a tip portion 432 formed such that an inward protruding amount in the radial direction gradually increases toward the base end portion 431 on the upstream side of the base end portion 431.

In this manner, separation of the flow of the air from the tip portion 432 toward the base end portion 431 can be suppressed. Therefore, a region having a low flow velocity and a high fuel concentration is less likely to be formed in the vicinity of the fuel injection hole 53 (in the vicinity of a fuel injection flow). As a result, it is possible to suppress a risk of flashback, which is backfire from the outlet 47 of the mixing flow path 46.

### Flow Path Wall 55

For example, as shown in FIG. 8, the flow path wall 55 forming the mixing flow path 46 is formed in a tubular shape such that the mixing flow path 46 having a circular cross section is defined inward, and functions as a mixing pipe for mixing the fuel and the air. As shown in FIG. 8, the flow path wall 55 forming the mixing flow path 46 (46a) of the first burner 42a and the flow path wall 55 forming the mixing flow path 46 (46b) of the second burner 42b share a bulkhead portion 58 (58ab) that divides the mixing flow path 46a of the first burner 42a and the mixing flow path 46b of the second burner 42b. In the exemplary form shown in FIG. 8, the flow path wall 55 of the mixing flow path 46 shares the bulkhead portion 58 with each of the flow path walls 55 of the plurality of mixing flow paths 46 (four mixing flow paths 46 in the form shown in the drawing) around the mixing flow path 46.

In addition, as shown in FIGS. 6 and 12, a thickness t2 of the bulkhead portion 58ab in the VI-VI cross section and the XII-XII cross section of the burner assembly 32 is constant in a direction along the central axis line O of the first burner 42a on the downstream side in the flow direction of the air with respect to the upstream-side end portion 61 in the flow direction of the air in the bulkhead portion 58ab. In addition, as shown in FIGS. 8 and 11, the thickness t2 of the bulkhead portion 58ab increases as the bulkhead portion 58ab is separated from the VI-IV cross section in FIG. 5, the C-C cross section in FIG. 8, and the XII-XII cross section in FIG. 11. As shown in FIG. 8, the C-C cross section is a cross section passing through a center C1 of the inlet 48 of the mixing flow path 46a of the first burner 42a and a center C2 of the inlet 48 of the mixing flow path 46b of the second burner 42b, and extending along the central axis line O of the mixing flow path 46 of the first burner 42a. The VI-IV cross section in FIG. 5 and the XII-XII cross section in FIG. 11 are cross sections at the same positions as the C-C cross section.

For example, as shown in FIG. 7, in the burner assembly 32, an end surface 59 (end surface on the upstream side in the flow direction of the air) of the bulkhead portion 58 that divides the two mixing flow paths 46 closest to each other has a saddle shape.

The inlet 48 (for example, refer to FIGS. 6 and 12) of the mixing flow path 46, which is a connection position between the introduction flow path 110 and the mixing flow path 46, is set as a boundary position between the introduction flow path wall 115 and the upstream-side end portion 61 in the flow direction of the air in the bulkhead portion 58ab. In addition, in a case of describing a distance in the direction of the central axis line O based on the inlet 48 of the mixing flow path 46, a position of the inlet 48 of the mixing flow path 46 in the direction of the central axis line O is set to a most downstream-side position inside the boundary positions as shown in FIGS. 6 and 12.

As shown in FIGS. 6 and 12, the thickness t2 of the bulkhead portion 58ab in the VI-VI cross section and the XII-XII cross section of the burner assembly 32 decreases toward the upstream side in the flow direction of the air in the upstream-side end portion 61 in the flow direction of the air in the bulkhead portion 58ab. In addition, in the VI-IV cross section in FIG. 5, the C-C cross section in FIG. 8, and the XII-XII cross section in FIG. 11, the upstream-side end surface 59 in the flow direction of the air in the bulkhead portion 58ab includes a protruding curve 60. In the exemplary form shown in the drawing, in the VI-IV cross section in FIG. 5, the C-C cross section in FIG. 8, and the XII-XII cross section in FIG. 11, the entire end surface 59 of the bulkhead portion 58ab is formed by the protruding curve 60 that is smoothly curved. In the cross sections VI-IV in FIG. 5, the cross section C-C in FIG. 8, and the cross section XII-XII in FIG. 11, the end surface 59 of the bulkhead portion 58ab may be formed in a streamline shape, for example.

Here, as shown in FIGS. 8 and 10, the protrusion portion 50 of the second fuel nozzle 43b is located on a side opposite to the protrusion portion 50 of the first fuel nozzle 43a across a plane V (refer to FIG. 10) including the C-C cross section.

As shown in FIG. 10, a height H of the bulkhead portion 58ab increases as the bulkhead portion 58ab is closer to the protrusion portion 50 of the first fuel nozzle 43a from a position of the plane V (position of the C-C cross section), and increases as the bulkhead portion 58ab is closer to the protrusion portion 50 of the second fuel nozzle 43b from the position of the plane V. In addition, in a cross section of the burner assembly 32B shown in FIG. 10, the upstream-side end surface 59 in the flow direction of the air in the bulkhead portion 58ab includes a concave curve 62 connecting the side surface 44 of the protrusion portion 50 of the first fuel nozzle 43a and the side surface 44 of the protrusion portion 50 of the second fuel nozzle 43b. As shown in FIG. 11, the X-X cross section is a cross section orthogonal to a straight line U (refer to FIG. 8) connecting the center C1 of the inlet 48 (refer to FIG. 6) of the mixing flow path 46a of the first burner 42a and the center C2 of the inlet 48 of the mixing flow path 46b of the second burner 42b.

### Regarding Diameter of Flow Path 100

In the burner assembly 32 shown in FIGS. 4 to 6, a first cross-sectional area S1 in the extending direction of the flow path 100, that is, in the introduction flow path 110 when viewed along the central axis line O, is larger than a second cross-sectional area S2 in the mixing flow path 46 when viewed along the central axis line O. Specifically, in the burner assembly 32 shown in FIGS. 4 to 6, in the upstream-side region in the flow direction of the air with respect to a position where the protrusion portion 51 appears inside the introduction flow path 110, an inner diameter Du of the introduction flow path 110 is larger than an inner diameter Dm of the mixing flow path 46a. In addition, as shown in FIG. 13, the inner diameter of the introduction flow path 110 in the peripheral wall portion 116 is equal to the inner diameter Du of the introduction flow path 110 in the upstream-side region in the flow direction of the air with respect to the position where the protrusion portion 51 appears inside the introduction flow path 110.

In the burner assembly 32 shown in FIGS. 11 and 12, the first cross-sectional area S1 in the introduction flow path 110 when viewed along the central axis line O is larger than the second cross-sectional area S2 in the mixing flow path 46 when viewed along the central axis line O. Specifically, in the burner assembly 32 shown in FIGS. 11 and 12, in the upstream-side region in the flow direction of the air with respect to the position where the protrusion portion 51 appears inside the introduction flow path 110, a corresponding diameter Due of the introduction flow path 110 is larger than the inner diameter Dm of the mixing flow path 46a. The corresponding diameter Due of the introduction flow path 110 is a diameter of a circle having a cross-sectional area equal to the cross-sectional area of the introduction flow path 110 when viewed along the central axis line O, In the following description, the corresponding diameter in the cross section is a diameter of a circle having the same cross-sectional area as the cross-sectional area of the cross section.

In the burner assembly 32 shown in FIGS. 4 to 6, 11, and 12, a diameter Dic (refer to FIGS. 5 and 13) of a virtual inscribed circle which is inscribed when viewed along the central axis line O with respect to the base end portion 431 in the plurality of protrusion portions 51 protruding into one introduction flow path 110, that is, a separation distance between the two base end portions 431 facing each other across the central axis line O when viewed along the central axis line O in the burner assembly 32 shown in FIGS. 4 to 6, 11, and 12 may be equal to or larger than the inner diameter Dm of the mixing flow path 46a as shown in FIGS. 13, 14, and 25 (to be described later).

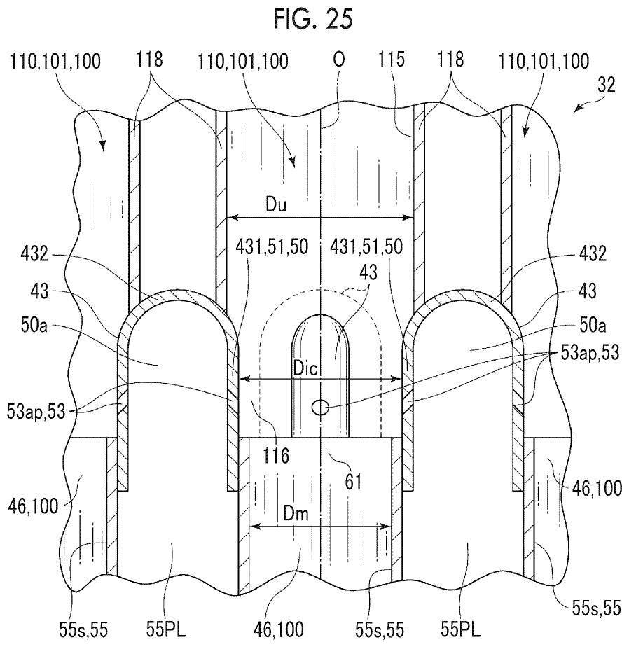

For example, as shown in FIG. 25 (to be described later), in the protrusion portion 50, the protrusion portion 50 being formed of a member different from the member forming the flow path wall 55 may be inserted into a fuel plenum 55PL, which is a space formed inside the flow path wall 55 and in which the fuel can be stored, and may be fixed to the flow path wall 55. In this manner, the protrusion portion 50 may be attached to the flow path wall 55. In this case, the diameter Dic of the inscribed circle may be larger than the inner diameter Dm of the mixing flow path 46a, or the diameter of the protrusion portion 50 on the upstream side with respect to a portion inserted into the flow path wall 55 may be increased. In this manner, the diameter Dic of the inscribed circle may be equal to the inner diameter Dm of the mixing flow path 46a.

When the protrusion portion 50 and the flow path wall 55 are integrally formed as in the exemplary forms shown in FIGS. 4 to 6, 11, and 12, as shown in FIGS. 5 and 13, the diameter Dic of the inscribed circle may be equal to the inner diameter Dm of the mixing flow path 46a, or may be larger than the inner diameter Dm of the mixing flow path 46a.

In the burner assembly 32 shown in FIGS. 4 to 6, 11, and 12, the upstream-side end portion 61 of the bulkhead portion 58, which separates the adjacent mixing flow paths 46, is located on the downstream side in the flow direction of the air from the peripheral wall portion 116 located between the two protrusion portions 51 adjacent to each other in the circumferential direction.

### Regarding Operational Effect of Burner Assembly 32

In the burner assembly 32 configured in this way, the compressed air flowing into the air flow path 36 from the casing 40 flows through a gap 23 in the axial direction between the burner assembly 32 and a bottom surface 21 of the casing 20, and flows into each of the introduction flow paths 110 provided in each of the plurality of burners 42 of the burner assembly 32.

The compressed air flowing into each of the introduction flow paths 110 is rectified in a process of flowing toward the downstream side in the flow direction of the air from the upstream-side end portion 111 (refer to FIG. 4) which is the upstream-side end portion of the introduction flow path 110 (upstream-side end portion of the flow path 100).

Since the second cross-sectional area S2 of the mixing flow path 46 is smaller than the first cross-sectional area S1 of the introduction flow path 110, the air flowing in an outer region in the radial direction inside the introduction flow path 110 flows to the downstream side while moving inward in the radial direction along the upstream-side end portion 61 of the bulkhead portion 58 when the air flows into the mixing flow path 46.

The fuel is injected into the flow path 100 from the fuel injection hole 53 formed on the side surface 44 of the protrusion portion 50 protruding inward in the radial direction.

As shown in FIGS. 6 and 12, the air flowing along the upstream-side end portion 61 of the bulkhead portion 58 flows into the mixing flow path 46 to enter between the fuel injected from the fuel injection hole 53 and the wall surface 55s of the flow path wall 55 of the mixing flow path 46. Therefore, a region having a high fuel concentration is less likely to be formed in the vicinity of the wall surface 55s of the flow path wall 55. As a result, it is possible to suppress a risk of flashback, which is backfire from the outlet 47 of the mixing flow path 46.

In addition, in the burner assembly 32 configured in this way, the fuel injection hole 53 is formed at a position closer to the inlet 48 than the upstream-side end portion 111 in the introduction flow path 110. In this manner, even when the air with a disturbed flow flows into the introduction flow path 110, the air is rectified in a process of reaching the vicinity of the fuel injection hole 53 (vicinity of the fuel injection flow) in the introduction flow path 110. Therefore, influence of the turbulence of the flow of the air before flowing into the introduction flow path 110 is suppressed, and a region having a low flow velocity and a high fuel concentration is less likely to be formed in the vicinity of the fuel injection hole 53 (vicinity of the fuel injection flow). As a result, a risk of flashback can be suppressed.

Since the combustor 4 according to the embodiment includes the burner assembly 32, the risk of flashback can be suppressed. Therefore, the combustor 4 can be stably used.

In the gas turbine 1 according to the embodiment, since the combustor 4 is provided, the risk of flashback can be suppressed, and the gas turbine can be stably operated.

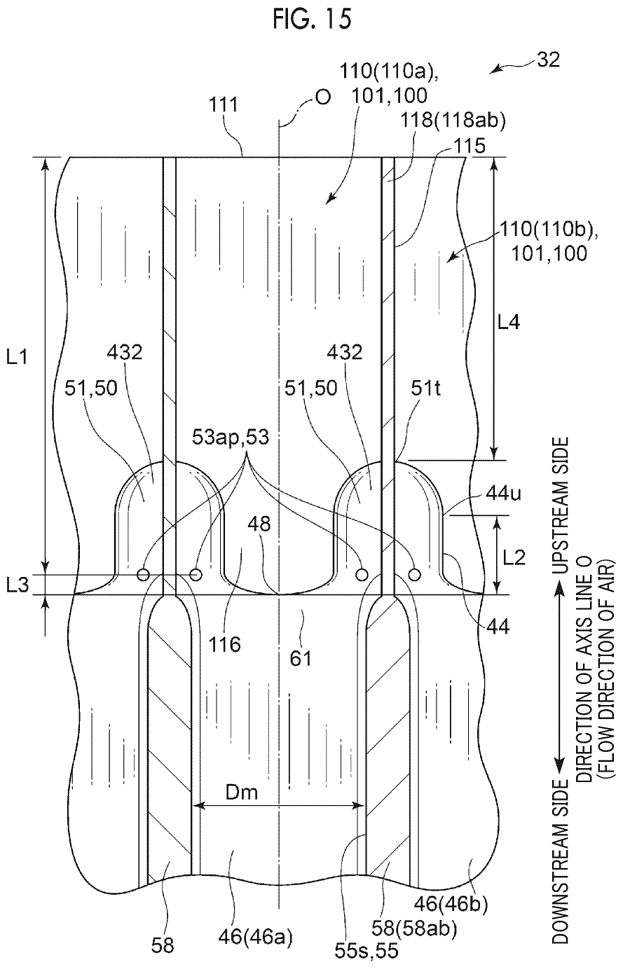

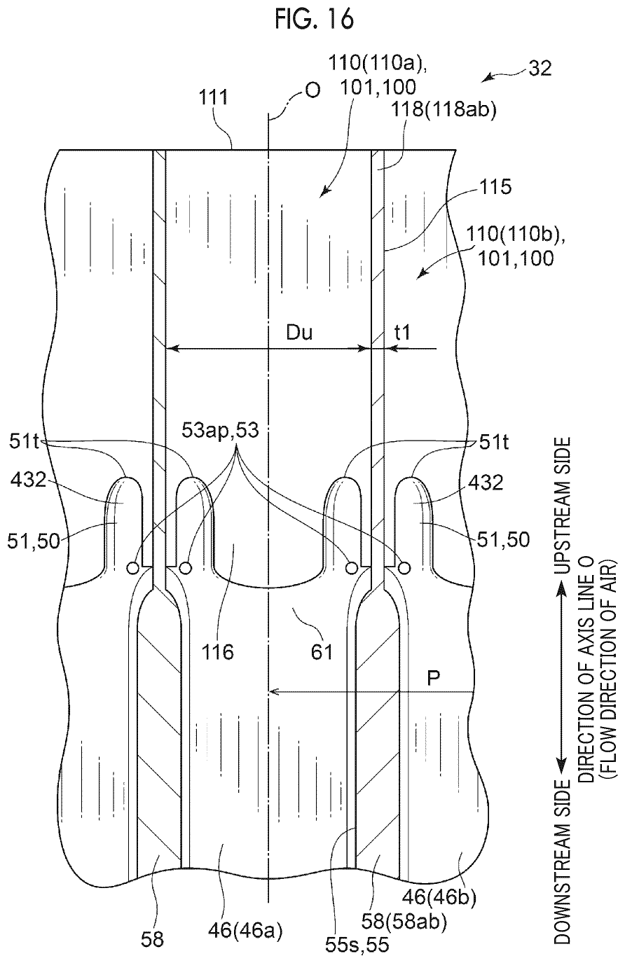

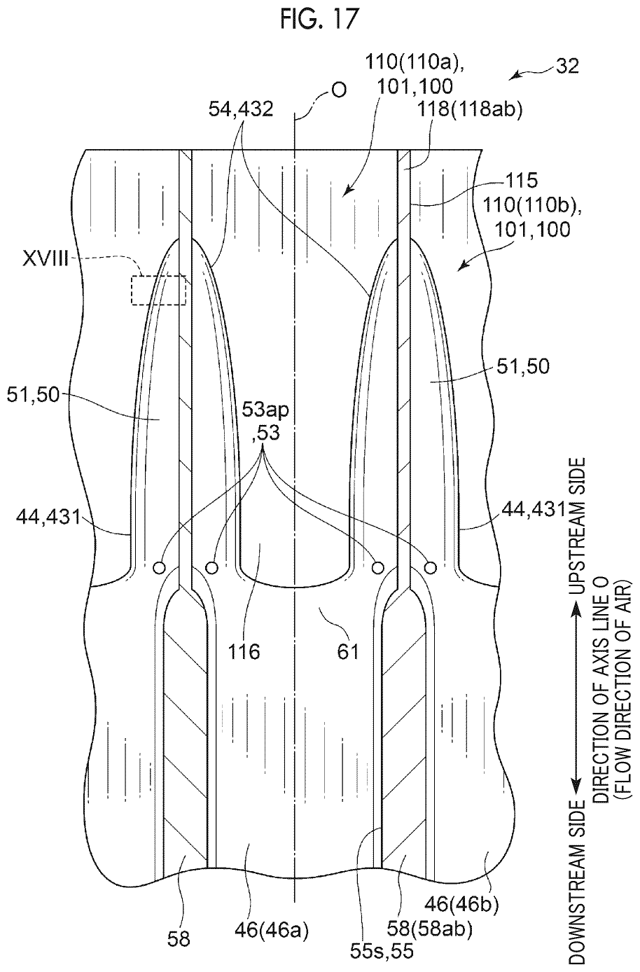

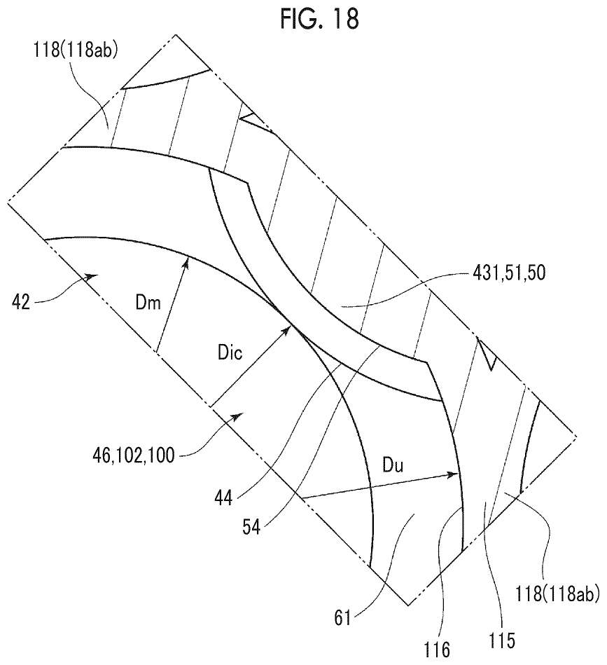

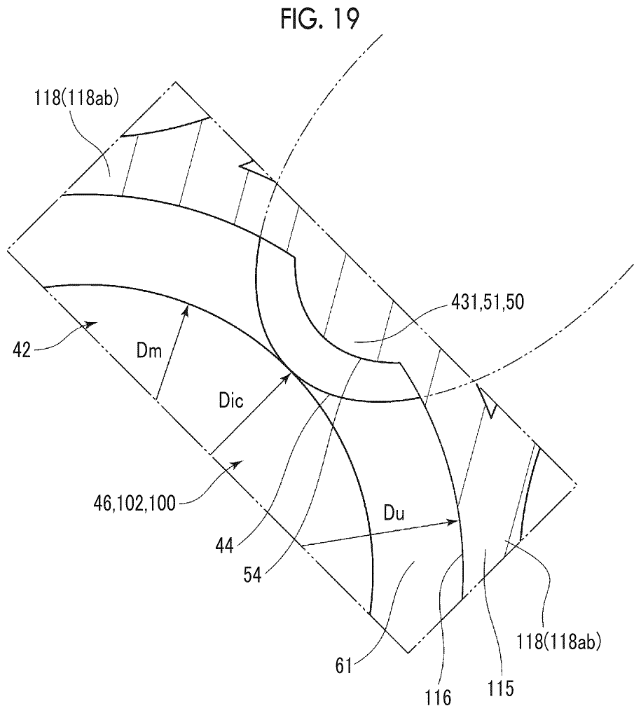

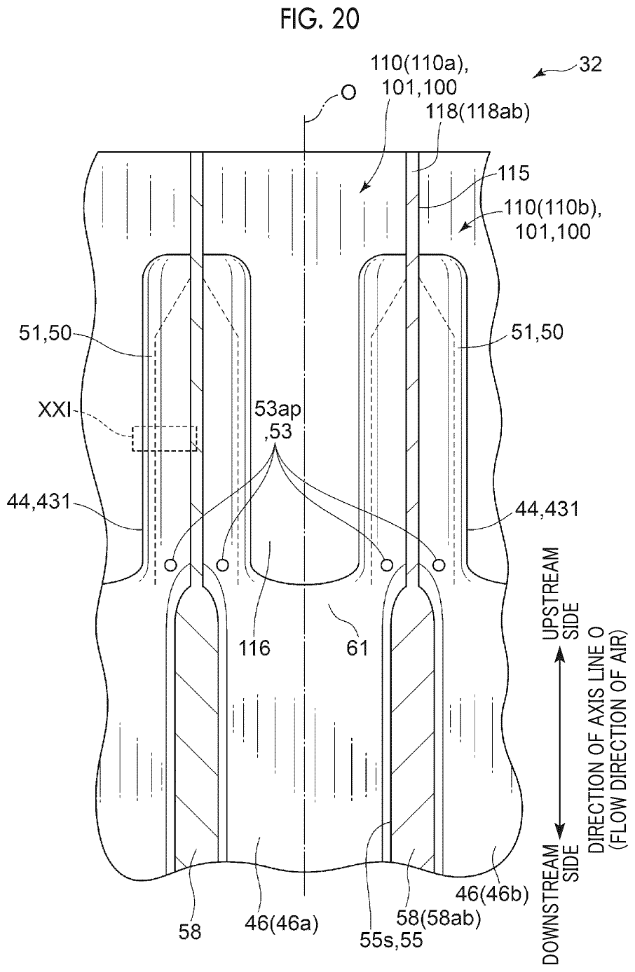

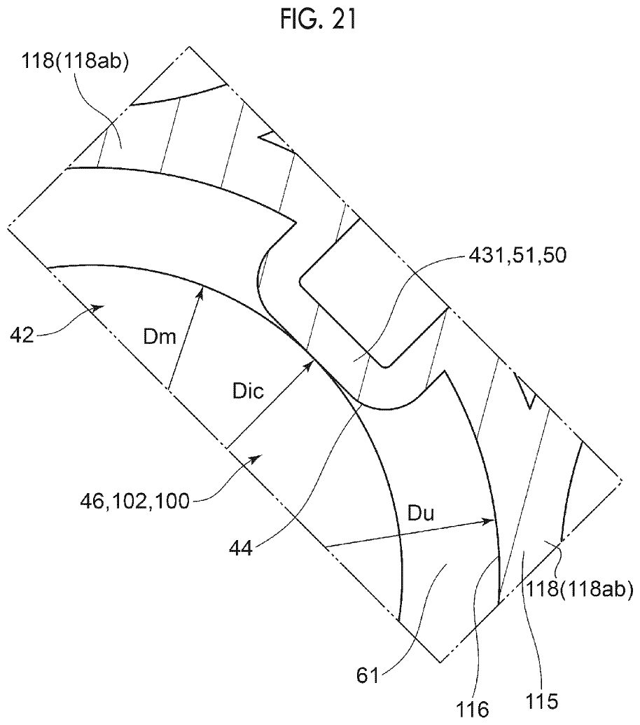

FIG. 15 is a view for describing dimensions of each portion of the burner assembly 32 according to some embodiments. FIG. 16 is a view for describing dimensions of each portion of the burner assembly 32 according to some embodiments. FIG. 17 is a view for describing a variation in a shape of the protrusion portion 50. FIG. 18 is a cross-sectional view when a XVIII portion surrounded by a broken line in FIG. 17 is viewed from the upstream side in the flow direction of the air. FIG. 19 is a view corresponding to a cross-sectional view when the XVIII portion surrounded by the broken line in FIG. 17 is viewed from the upstream side in the flow direction of the air, and shows another example. FIG. 20 is a view for describing a variation in the shape of the protrusion portion 50. FIG. 21 is a cross-sectional view when a XXI portion surrounded by a broken line in FIG. 20 is viewed from the upstream side in the flow direction of the air.

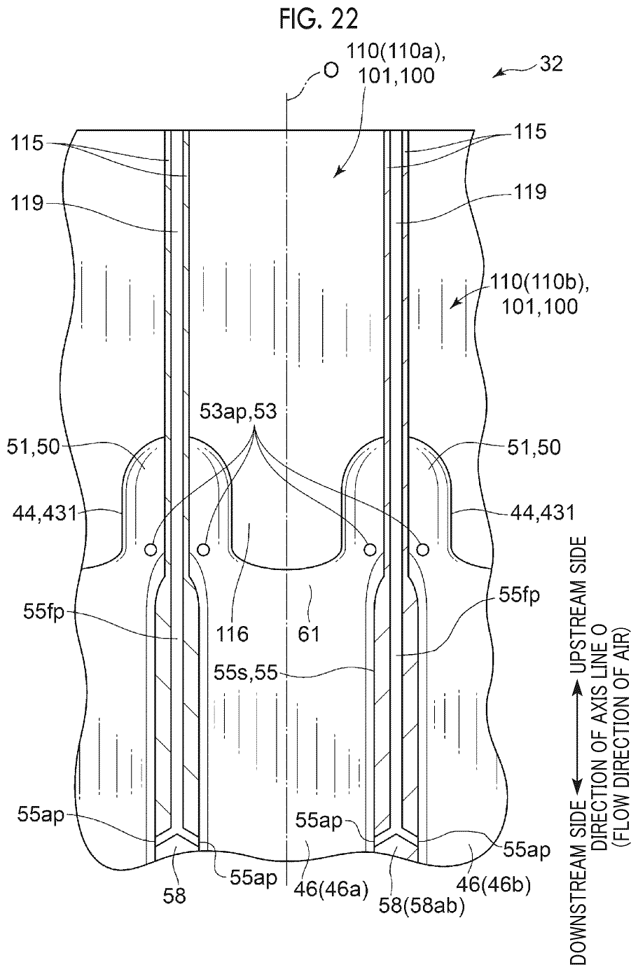

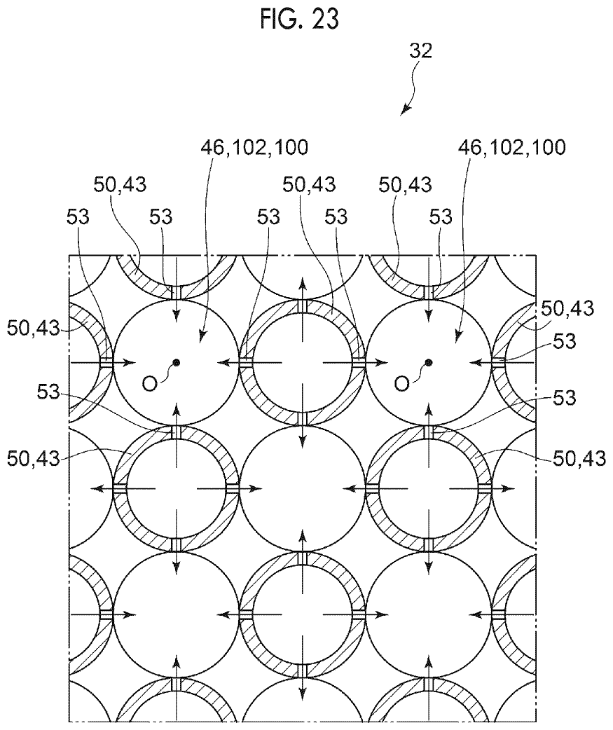

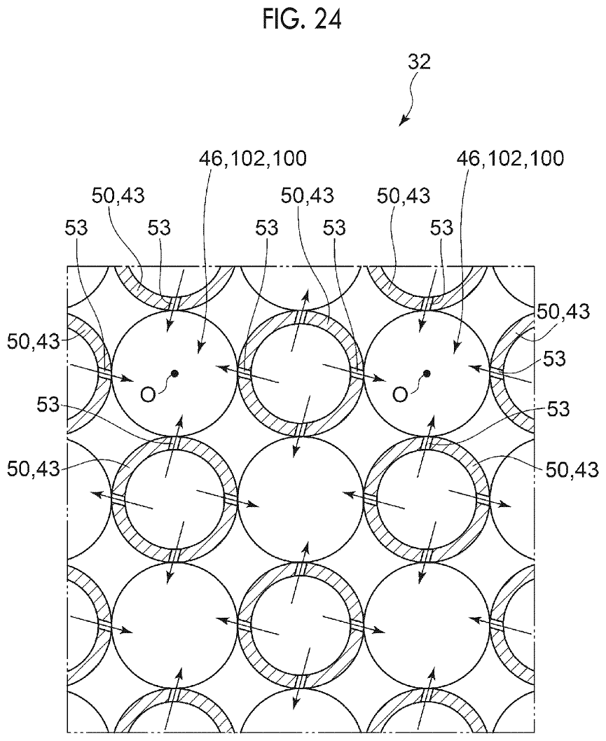

FIG. 22 is a view for describing a modification example of the introduction flow path wall 115 and the flow path wall 55. FIG. 23 is a schematic view for describing the extending direction of the fuel injection hole 53, and shows a cross section orthogonal to the central axis line O. FIG. 24 is a schematic view for describing the extending direction of the fuel injection hole 53, and shows a cross section orthogonal to the central axis line O. FIG. 25 is a view showing another example of the protrusion portion 50 of the fuel nozzle 43, and is a view corresponding to a cross-sectional view along line XXV-XXV in FIG. 5.

### Dimensions of Each Portion of Burner Assembly 32

In the burner assembly 32 according to some embodiments, as shown in FIG. 15, a first distance LI in the extending direction of the central axis line O between the upstream-side end portion 111 of the flow path 100 and a center position of an opening 53ap in the protrusion portion 51 of the fuel injection hole 53 may be equal to or larger than 1 time, and may be preferably equal to or larger than 5 times the inner diameter Dm of the mixing flow path 46 when viewed in the extending direction of the central axis line O.

In this manner, since the air can be effectively rectified in the introduction flow path 110, the risk of flashback can be effectively suppressed.

When a cross-sectional shape of the mixing flow path 46 when viewed in the extending direction of the central axis line O is other than a circle, the inner diameter Dm is the corresponding diameter of the mixing flow path 46.

In the burner assembly 32 according to some embodiments, a second distance L2 in the extending direction between the inlet 48 of the mixing flow path 46 and the upstream-side end portion 44u on the side surface 44 of the protrusion portion 50 may be equal to or smaller than 1 time the inner diameter Dm of the mixing flow path 46 when viewed in the extending direction of the central axis line O.

In this manner, formation of a low velocity region can be suppressed in the vicinity of the wall surface of the flow path 100 by suppressing an increase in the length of the protrusion portion 51 along the extending direction of the central axis line O.

When a cross-sectional shape of the mixing flow path 46 when viewed in the extending direction of the central axis line O is other than a circle, the inner diameter Dm is the corresponding diameter of the mixing flow path 46.

In the burner assembly 32 according to some embodiments, a third distance L3 in the extending direction of the central axis line O between the inlet 48 of the mixing flow path 46 and the center position of the opening 53ap in the protrusion portion 51 of the fuel injection hole 53 may be larger than an opening diameter dap of the opening 53ap, and may be smaller than the second distance L2.

As described above, when the air flows into the mixing flow path 46 from the introduction flow path 110, the cross-sectional area of the flow path 100 when viewed in the extending direction of the flow path 100 is reduced. Therefore, an inward flow in the radial direction in the vicinity of the inlet 48 of the mixing flow path 46 is generated in the air flowing into the mixing flow path 46 from the introduction flow path 110. In this manner, the fuel ejected from the fuel injection hole 53 is less likely to form a region having a high fuel concentration in the vicinity of the wall surface 55s of the mixing flow path 46. As a result, a risk of flashback can be suppressed.

However, when the third distance L3 is equal to or smaller than the opening diameter dap of the opening 53ap, the fuel injection hole 53 is excessively close to the mixing flow path 46. Therefore, the air is less likely to enter between the fuel injected from the fuel injection hole 53 and the wall surface 55s of the flow path wall 55 of the mixing flow path 46. Consequently, there is a possibility of reducing an advantageous effect of the present disclosure in which a region having a high fuel concentration is less likely to be formed in the vicinity of the wall surface 55s of the mixing flow path 46.

In addition, when the third distance L3 is equal to or larger than the second distance L2, the fuel injection hole 53 is excessively separated to the upstream side from the vicinity of the inlet 48 of the mixing flow path 46 in which the inward flow of the air in the radial direction is generated. Therefore, there is a possibility that the region having the high fuel concentration is likely to be formed in the vicinity of the inner wall of the introduction flow path 110.

According to the burner assembly 32 according to some embodiments, the fuel ejected from the fuel injection hole 53 is less likely to form the region having the high fuel concentration in the vicinity of the introduction flow path 110 or the inner wall of the mixing flow path 46. Therefore, the risk of flashback can be suppressed.

In the burner assembly 32 according to some embodiments, a fourth distance L4 in the extending direction of the central axis line O between the upstream-side end portion 111 of the introduction flow path 110 and the upstream-side end portion 51t (refer to FIG. 15) of the protrusion portion 51 may be equal to or larger than 0.

In this manner, the risk of flashback can be suppressed while a rectifying effect of the air in the introduction flow path 110 can be ensured.

As shown in FIG. 16, in the burner assembly 32 according to some embodiments, when the upstream-side end portion 51t of the protrusion portion 51 is located on the downstream side of the upstream-side end portion 111 of the introduction flow path 110, the inner diameter Du when at least a portion of a region on the upstream side of the end portion 432t inside the introduction flow path 110 is viewed in the extending direction of the central axis line O may be equal to a value (Du=P−2×t1) obtained by subtracting twice the thickness t1 of the bulkhead portion 118 (118ab) that separates the introduction flow path 110 (110a) in the first flow path 100a and the introduction flow path 110 (110b) in the second flow path 100b from a separation distance P between the central axis line O of the introduction flow path 110 (110a) in the first flow path 100a and the central axis line O of the introduction flow path 110 (110b) in the second flow path 100b.

In this manner, the inner diameter Du of the introduction flow path 110 can be adjusted by appropriately adjusting the thickness t1 of the bulkhead portion 118 (118ab) that separates the introduction flow path 110 (110a) in the first flow path 100a and the introduction flow path 110 (110b) in the second flow path 100b.

In the burner assembly 32 according to some embodiments, for example, as shown in FIG. 7, the top surface 54 of the tip portion 432 may have an arc shape in a cross section taken along the extending direction of the central axis line O. That is, in the burner assembly 32 according to some embodiments, the convex curved surface 56 may be a spherical surface.

In this manner, while the distance from the upstream-side end portion 111 of the introduction flow path 110 to the base end portion 431 can be suppressed, a configuration can be adopted such that the flow of the air is less likely to be disturbed from the tip portion 432 to the base end portion 431. Therefore, it is easy to ensure the advantageous effect of the present disclosure in which the region having the high fuel concentration is less likely to be formed in the vicinity of the wall surface 55s of the mixing flow path 46.

In the burner assembly 32 according to some embodiments, the convex curved surface 56 may be a conical surface or a pyramidal surface instead of the spherical surface. When the convex curved surface 56 is the conical surface or the pyramidal surface, a surface shape may be gently changed from the base end portion 431 to the conical surface or the pyramidal surface.

In addition, in the burner assembly 32 according to some embodiments, for example, the convex curved surface 56 may be an ogive shape like a nose cone of a tip of a rocket, or may be a rotational surface of a secondary curve such as a parabola.

In the burner assembly 32 according to some embodiments, for example, as shown in FIG. 17, the top surface 54 of the tip portion 432 may have an elliptical arc shape in the cross section taken along the extending direction of the central axis line O.

In this manner, for example, as shown in FIG. 17, when a major axis of the elliptical arc extends along the extending direction of the central axis line O, compared to a case where the top surface 54 of the tip portion 432 has the arc shape in the cross section taken along the extending direction as shown in FIG. 7, a configuration can be adopted such that the flow of the air is less likely to be disturbed from the tip portion 432 to the base end portion 431. Therefore, it is easy to ensure the advantageous effect of the present disclosure in which the region having the high fuel concentration is less likely to be formed in the vicinity of the wall surface 55s of the mixing flow path 46.

In addition, for example, when a minor axis of the elliptical arc extends along the extending direction of the central axis line O, compared to a case where the top surface 54 of the tip portion 432 has the arc shape in the cross section taken along the extending direction as shown in FIG. 7, the distance from the upstream-side end portion 111 of the introduction flow path 110 to the base end portion 431 can be suppressed, and an increase in a total length of the flow path 100 can be suppressed.

A shape of the protrusion portion 51 of the tip portion 432 protruding into the introduction flow path 110 may be a shape in which a cross section appearing in a plane orthogonal to the central axis line O has a circular shape as shown in FIG. 18, for example, or may be a shape in which the cross section appearing in the plane orthogonal to the central axis line O has an elliptical shape as shown in FIG. 19, for example.

In an example shown in FIG. 19, a vertex located on the major axis of the elliptical shape protrudes into the introduction flow path 110, but a vertex located on the minor axis of the elliptical shape may protrude into the introduction flow path 110.

In the burner assembly 32 according to some embodiments, the protrusion portion 51 may have a shape other than the circular shape or the elliptical shape in a cross section appearing in a plane (FIG. 21) in which the base end portion 431 is orthogonal to the central axis line O as shown in FIGS. 20 and 21, for example, and may have a rectangular shape having rounded four corners, for example.

In the burner assembly 32 according to some embodiments, the protrusion portion 50 may have a hollow shape having a space 50a which can internally store the fuel as shown in FIGS. 20, 21, and 23 to 25, for example.

Although omitted in FIGS. 9 and 10, as shown in FIG. 25, the fuel plenum 55PL as a space communicating with the space 50a and which can store the fuel may be formed inside the flow path wall 55 on the downstream side in the flow direction of the air with respect to the protrusion portion 50.

### Modification Example of Introduction Flow Path Wall 115 and Flow Path Wall 55

As shown in FIG. 22, a gap may be provided between the introduction flow path wall 115 forming the introduction flow path 110 (110a) of the first burner 42a and the introduction flow path wall 115 forming the introduction flow path 110 (110b) of the second burner 42b, and the gap may be used as a flow path 119 of the compressed air. A flow path 55fp connecting an opening 55ap open to the wall surface 55s of the flow path wall 55 forming the mixing flow path 46 and the flow path 119 may be provided, and the compressed air from the flow path 119 may be ejected from the opening 55ap to perform film-cooling on the wall surface 55s of the flow path wall 55. A position of the opening 55ap in the direction of the central axis line O may be in the vicinity of the outlet 47 (refer to FIG. 4) of the mixing flow path 46.

### Regarding Extending Direction of Fuel Injection Hole 53

For example, as shown in FIG. 23, each of the fuel injection holes 53 may extend in a direction orthogonal to the central axis line O to inject the fuel toward the central axis line O of the flow path 100.

In addition, for example, as shown in FIG. 24, each of the fuel injection holes 53 may extend in an oblique direction with respect to the direction orthogonal to the central axis line O.

In examples shown in FIGS. 23 and 24, each of the fuel injection holes 53 may extend along a plane orthogonal to the central axis line O, or may be inclined toward the downstream side in the flow direction of the air as shown in FIG. 25.

### Other Embodiments of First Region 101

For example, as shown in FIG. 4, in the burner assembly 32 according to some embodiments described above, in the upstream-side end portion 111 which is the upstream-side end portion of the introduction flow path 110 (upstream-side end portion of the flow path 100), the introduction flow path wall 115 forming the introduction flow path 110 has a flat surface extending in the direction orthogonal to the central axis line O of the flow path 100.

When this flat surface is present, there is the following risk. The air flowing from the outside along the extending direction of the central axis line O collides with the flat surface to disturb the flow, and the air flows while being separated from the inner peripheral surface in the vicinity of the inlet of the introduction flow path 110. Even when the flow of the air is slightly disturbed, in the burner assembly 32 according to the some embodiments described above, the air is rectified in a process of flowing through the introduction flow path 110, and the risk of flashback is reduced.

In the burner assembly 32 according to another embodiment described below, an inlet region 112 (to be described later) is provided in the introduction flow path 110 such that the flow of the air when the air flows into the introduction flow path 110 is smooth.

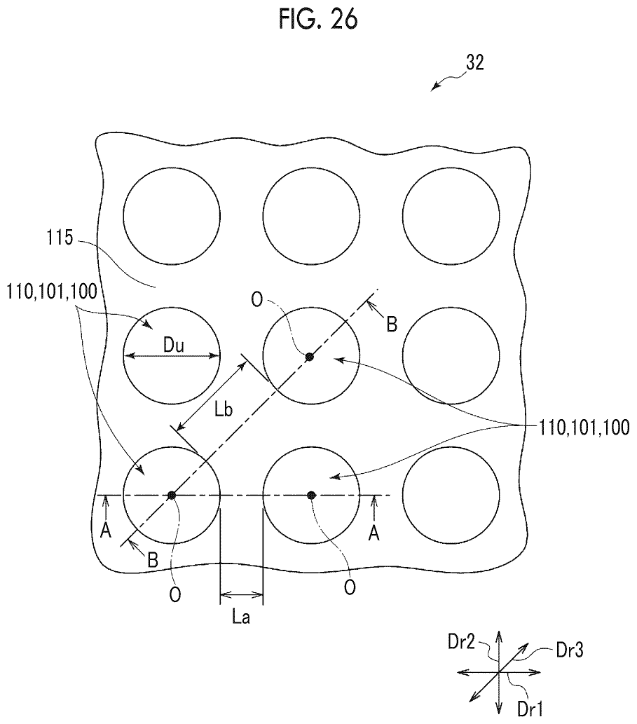

FIG. 26 is a schematic view when a portion of the burner assembly 32 according to a modification example of the first region 101 is viewed from the upstream side in the flow direction of the air along the central axis line L.

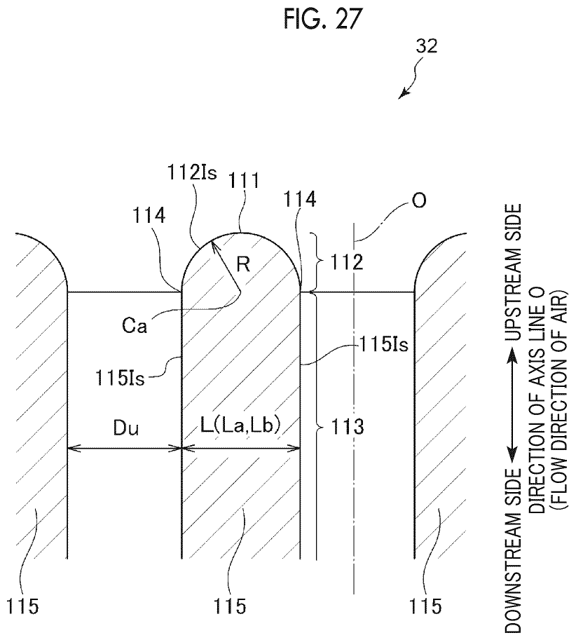

FIG. 27 is a schematic cross-sectional view of the first region 101 (introduction flow path 110) appearing in a cross section including the central axis line O of the flow path 100, and shows an A-A cross section or a B-B cross section in FIG. 26.

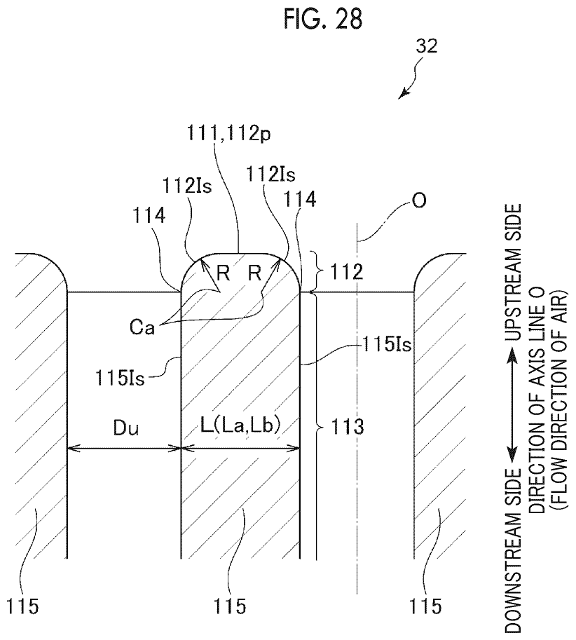

FIG. 28 is a schematic cross-sectional view of the first region 101 (introduction flow path 110) appearing in the cross section including the central axis line O of the flow path 100, and shows the A-A cross section or the B-B cross section in FIG. 26.

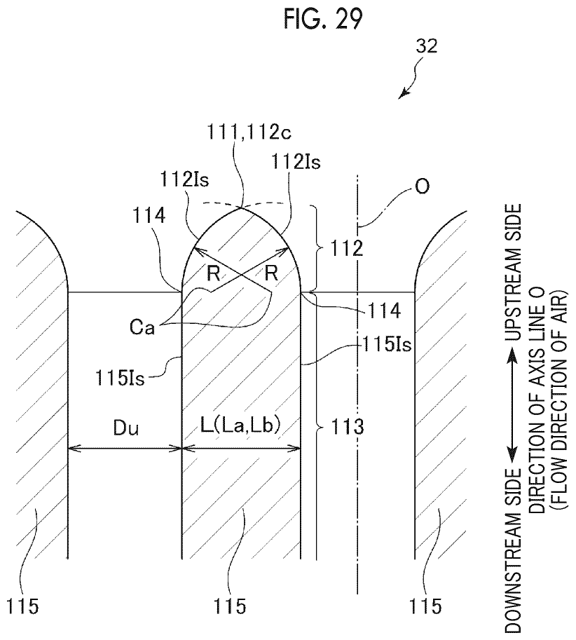

FIG. 29 is a schematic cross-sectional view of the first region 101 (introduction flow path 110) appearing in the cross section including the central axis line O of the flow path 100, and shows the A-A cross section or the B-B cross section in FIG. 26.

In FIGS. 27, 28, and 29, sizes of curvature radii R (to be described later) are different.

In the burner assembly 32 according to another embodiment, for example, a plurality of the introduction flow paths 110 are disposed at an equal interval along a first direction Dr1 orthogonal to the extending direction of the flow path 100 (extending direction of the central axis line O) and a second direction Dr2 orthogonal to the extending direction of the central axis line O and the first direction Dr1.

As shown in FIG. 26, in the burner assembly 32 according to another embodiment, in the introduction flow path 110, the inner peripheral surfaces (inner wall surfaces 115Is) of the introduction region 113 (to be described later) adjacent to each other in the first direction Dr1 are separated from each other by a distance La.

For convenience of description, in the burner assembly 32 according to another embodiment, in the introduction flow path 110, the inner wall surfaces 115Is of the introduction regions 113 adjacent to each other in the second direction Dr2s are separated from each other by the distance La or larger.

In the burner assembly 32 according to another embodiment, a direction extending in a direction different from the first direction and the second direction and orthogonal to the extending direction of the central axis line O will be referred to as a third direction Dr3.

In the burner assembly 32 according to another embodiment, in the introduction flow path 110, the inner wall surfaces 115Is of the introduction regions 113 adjacent to each other in the third direction Dr3 are separated from each other by a distance Lb.

In this case, an angle difference between the first direction Dr1 and the third direction Dr3 is 45 degrees or larger and smaller than 90 degrees since the inner wall surfaces 115Is of the introduction regions 113 adjacent to each other in the second direction Dr2 are separated from each other by the distance La or larger.

The introduction flow path 110 according to another embodiment includes an inlet region 112 including the upstream-side end portion 111 and an introduction region 113 connected to the inlet region 112 on the downstream side of the inlet region 112.

The inlet region 112 is defined by an inner wall surface 112Is formed in a curved shape convex inward of the first region 101 in a cross section along the extending direction of the flow path 100 (extending direction of the central axis line O), as shown in FIGS. 27 to 29 and each drawing described later, for example, and is formed such that a cross-sectional area of the flow path 100 gradually decreases toward the downstream side.

In the introduction flow path 110 according to another embodiment, in the inlet region 112, for example, in a cross section taken along the extending direction of the central axis line O, a position of a center (curvature center) Ca of the curvature radius R of the inner wall surface 112Is is set such that the inner wall surface 112Is is convex inward of the first region 101.

In the cross section taken along the extending direction (direction of the axis line O) of the central axis line O, the introduction region 113 is defined by the inner wall surface formed in a linear shape parallel to the extending direction of the central axis line O, that is, the inner wall surface 115Is of the introduction flow path wall 115. That is, an inner peripheral surface of the introduction region 113 is the inner wall surface 115Is of the introduction flow path wall 115.

The introduction region 113 has the same configuration as the introduction flow path 110 of some embodiments described above. As in some embodiments described above, the downstream side of the introduction region 113 is connected to the mixing flow path 46 and the inlet 48 (for example, refer to FIGS. 6 and 12) of the mixing flow path 46. In other words, the introduction flow path 110 according to another embodiment has a form in which the inlet region 112 is added to the upstream side of the introduction flow path 110 according to some embodiments described above.

The inlet region 112 and the introduction region 113 according to another embodiment are connected to each other at a connection position 114 between both of these. At the connection position 114, the inner wall surface 112Is that defines the inlet region 112 and the inner wall surface 115Is that defines the introduction region 113 are smoothly connected to each other without a step difference over the entire periphery of the connection position 114.

That is, in the introduction flow path 110 according to another embodiment, in the cross section taken along the extending direction of the central axis line O (direction of the axis line O), the position in the direction of the axis line O of the curvature center Ca of the inner wall surface 112Is in the vicinity of at least the connection position 114 inside the inner wall surface 112Is that defines the inlet region 112 is set to coincide with a position of the connection position 114 in the direction of the axis line O.

Since the position of the curvature center Ca in the direction of the axis line O is set in this way, in the cross section taken along the extending direction of the central axis line O (direction of the axis line O), a tangent direction of the inner wall surface 112Is at the connection position 114 coincides with the direction of the axis line O. In this manner, the inner wall surface 112Is that defines the inlet region 112 and the inner wall surface 115Is that defines the introduction region 113 can be smoothly connected to each other over the entire periphery of the connection position 114.

### Regarding Size of Curvature Radius R and Shape of Inner Wall Surface 112Is

For example, FIG. 27 shows a case where the curvature radius R in the cross section shown in FIG. 27 is 0.5 times (R=0.5×L) the distance L (for example, the distance La and the distance Lb) between the inner wall surfaces 115Is of the adjacent introduction regions 113 in the cross section.

In this case, the inner wall surface 112Is that defines the inlet region 112 has a semi-arc shape, and is smoothly connected to each of the inner wall surfaces 115Is of the two adjacent introduction regions 113 in the cross section, at the connection position 114.

For example, FIG. 28 shows a case where the curvature radius R in the cross section shown in FIG. 28 is smaller than 0.5 times (R<0.5×L) the distance L between the inner wall surfaces 115Is of the adjacent introduction regions 113 in the cross section.

In this case, for example, the inner wall surface 112Is of the inlet region 112 connected from the inner wall surface 115Is is smoothly connected to the inner wall surface 115Is of the introduction region 113, for example, on the left side in the drawing inside the inner wall surface 115Is of the two adjacent introduction regions 113 in the cross section, at the connection position 114. In addition, the inner wall surface 112Is of the inlet region 112 connected from the inner wall surface 115Is is smoothly connected to the inner wall surfaces 115Is of the introduction region 113, for example, on the right side in the drawing inside the inner wall surface 115Is of the two adjacent introduction regions 113 in the cross section, at the connection position 114.

In this case, the inner wall surface 112Is of the inlet region 112 on the left side in the drawing and the inner wall surface 112Is of the inlet region 112 on the right side in the drawing cannot be connected to each other while the curvature radius is maintained, or even when the inner wall surfaces 112Is are connected to each other, the connection portion has a shape depressed to the downstream side.

Therefore, when the curvature radius R is smaller than 0.5 times the distance L (R<0.5×L), the upstream-side end portion 111 is formed by the flat surface 112p, and the inner wall surface 112Is of the inlet region 112 on the left side in the drawing and the inner wall surface 112Is of the inlet region 112 on the right side in the drawing are smoothly connected to the flat surface 112p. In this case, the distance in the direction of the axis line O between the flat surface 112p and the connection position 114 is equal to the curvature radius R.

For example, FIG. 29 shows a case where the curvature radius R in the cross section shown in FIG. 29 exceeds 0.5 times the distance L between the inner wall surfaces 115Is of the adjacent introduction regions 113 in the cross section (R>0.5×L).

In this case, for example, the inner wall surface 112Is of the inlet region 112 connected from the inner wall surface 115Is is smoothly connected to the inner wall surface 115Is of the introduction region 113, for example, on the left side in the drawing inside the inner wall surface 115Is of the two adjacent introduction regions 113 in the cross section, at the connection position 114. In addition, the inner wall surface 112Is of the inlet region 112 connected from the inner wall surface 115Is is smoothly connected to the inner wall surfaces 115Is of the introduction region 113, for example, on the right side in the drawing inside the inner wall surface 115Is of the two adjacent introduction regions 113 in the cross section, at the connection position 114.

The inner wall surface 112Is of the inlet region 112 on the left side in the drawing and the inner wall surface 112Is of the inlet region 112 on the right side in the drawing are connected to each other.

In this case, a connection portion 112c between the inner wall surface 112Is of the inlet region 112 on the left side of the drawing and the inner wall surface 112Is of the inlet region 112 on the right side of the drawing has a pointed shape in the cross section shown in FIG. 29.

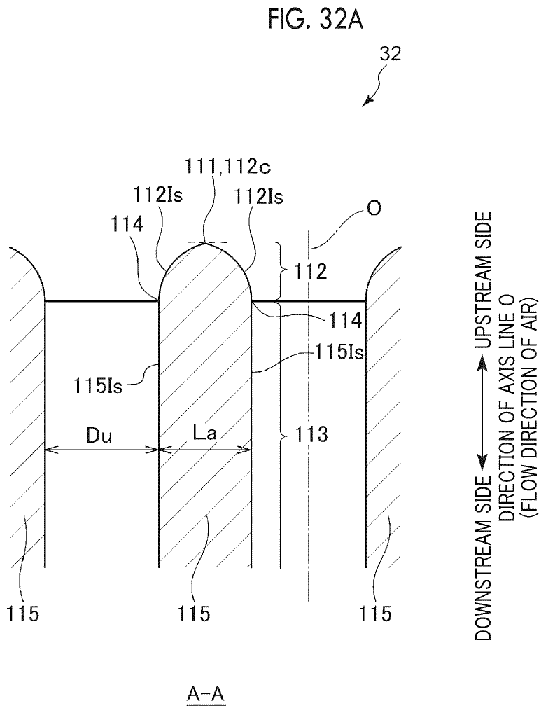

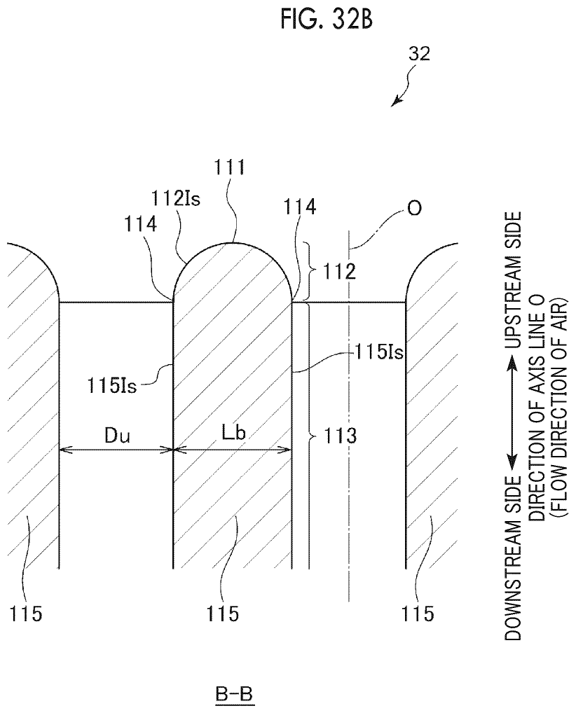

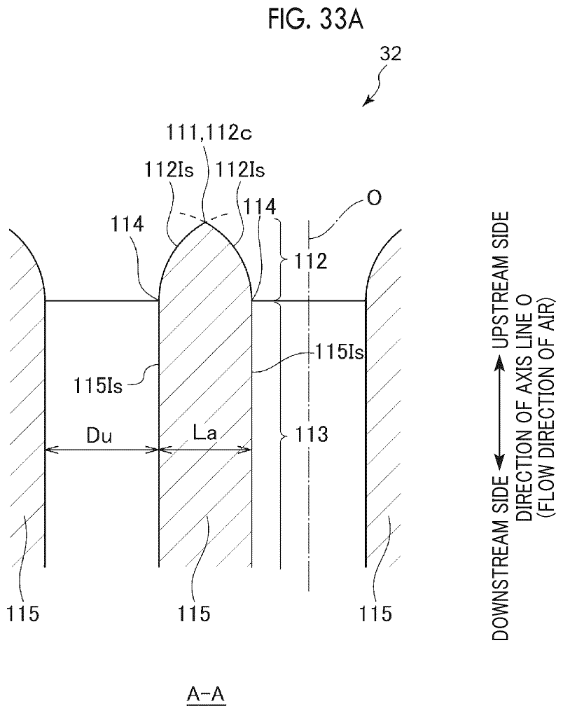

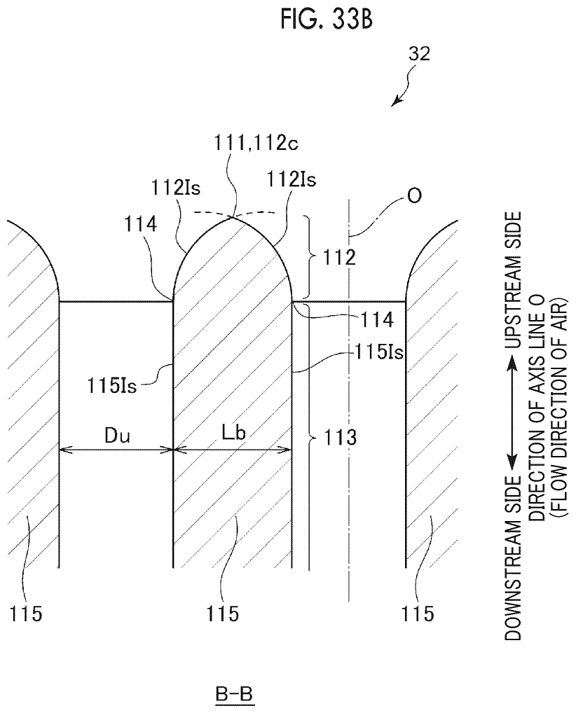

In FIG. 29, a broken line arc extending from the connection portion 112c is a virtual line when the inner wall surface 112Is of the inlet region 112 on the left side of the drawing extends to the right side of the drawing, and a virtual line when the inner wall surface 112Is of the inlet region 112 on the right side of the drawing extends to the left side of the drawing, and both are arcs having the curvature radius R. The same applies to FIGS. 32A, 33A, and 33B (to be described later).

With regard to the inlet region 112 configured in this way, some examples will be described in which a relationship between the distance La and the distance Lb and the curvature radius R is changed. The distance Lb is larger than the distance La.

### Case of R<0.5×La

A case will be described where the curvature radius R is constant over the entire periphery of the inlet region 112 and is smaller than 0.5 times the distance La (R<0.5×La).

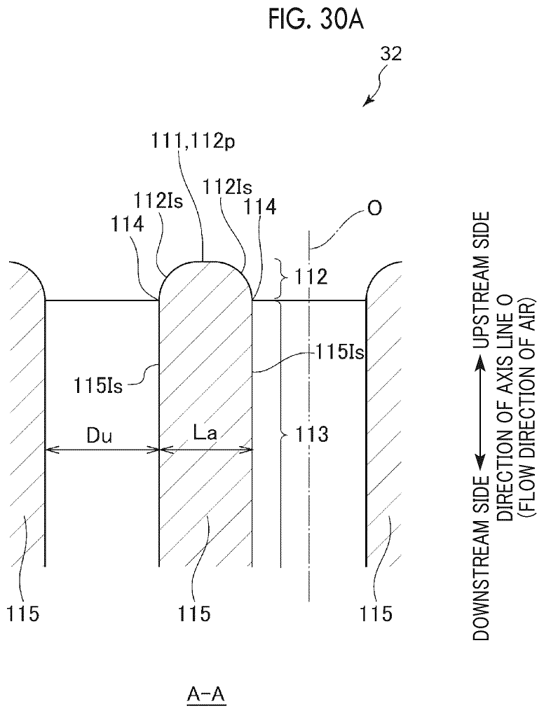

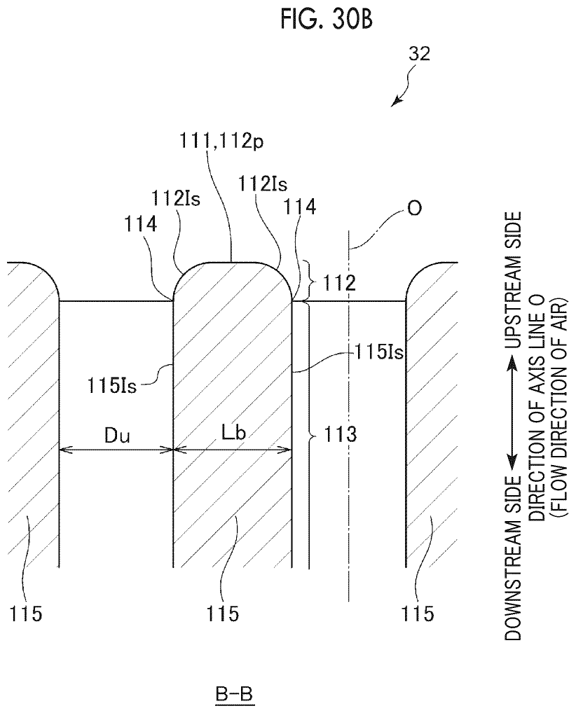

FIG. 30A is a schematic cross-sectional view showing the A-A cross section in FIG. 26 when the curvature radius R is smaller than 0.5 times the distance La (R<0.5×La).

FIG. 30B is a schematic cross-sectional view showing the B-B cross section in FIG. 26 when the curvature radius R is smaller than 0.5 times the distance La (R<0.5×La).

When the curvature radius R is smaller than 0.5 times the distance La (R<0.5×La), the shape of the inlet region 112 in both the A-A cross section in FIG. 26 and the B-B cross section in FIG. 26 is the same as the shape shown in FIG. 28. That is, when the curvature radius R is smaller than 0.5 times the distance La (R<0.5×La), the upstream-side end portion 111 is formed by the flat surface 112p in both the A-A cross section in FIG. 26 and the B-B cross section in FIG. 26. That is, when the curvature radius R is smaller than 0.5 times the distance La (R<0.5×La), the inlet region 112 is surrounded by the flat surface 112p over the entire periphery.

However, when the curvature radius R is smaller than 0.5 times the distance La (R<0.5×La), the inlet region 112 is formed by the inner wall surface 112Is having a curve of the curvature radius R in the cross section taken along the direction of the axis line O, except for the flat surface 112p. Therefore, when the air flows into the inlet region 112, the air is easily guided into the inlet region 112. Therefore, the air is less likely to be separated from the inner peripheral surfaces (inner wall surface 112Is and inner wall surface 115Is) of the inlet region 112 and the introduction region 113. In this manner, a pressure loss in the first region 101 (introduction flow path 110) can be reduced, and a flow path deviation in the first region 101 (introduction flow path 110) can be reduced. Therefore, the risk of flashback can be further effectively suppressed.

### Case of R=0.5×La

A case will be described where the curvature radius R is constant over the entire periphery of the inlet region 112 and is 0.5 times (R=0.5×La) the distance La.

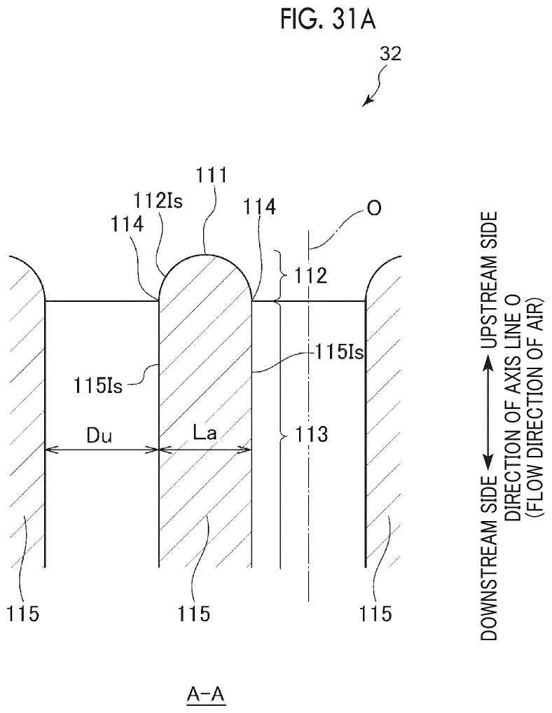

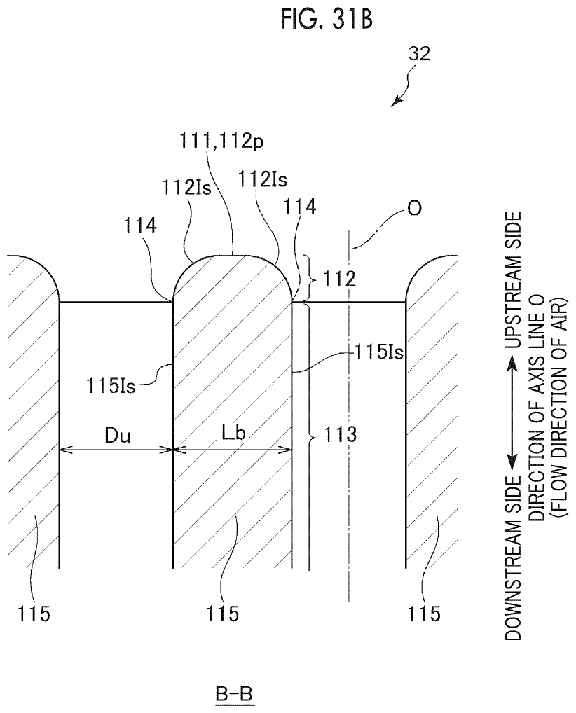

FIG. 31A is a schematic cross-sectional view showing the A-A cross section in FIG. 26 when the curvature radius R is 0.5 times (R=0.5×La) the distance La.

FIG. 31B is a schematic cross-sectional view showing the B-B cross section in FIG. 26 when the curvature radius R is 0.5 times (R=0.5×La) the distance La.

That is, in the burner assembly 32 according to another embodiment, in each of the inlet regions 112, the inner peripheral surface (inner wall surface 112Is) of the inlet region 112 appearing in the cross section of the inlet region 112 along the direction of the axis line O may be formed in a curved shape having the curvature radius R of 0.5 times the distance La between the inner peripheral surfaces (inner wall surfaces 115Is) of the introduction regions 113 adjacent to each other in the first direction Dr1.

When the curvature radius R is 0.5 times the distance La (R=0.5×La), the shape of the inlet region 112 in the A-A cross section in FIG. 26 is the same as the shape shown in FIG. 27. That is, when the curvature radius R is 0.5 times the distance La (R=0.5×La), in the A-A cross section in FIG. 26, the inner wall surface 112Is that defines the inlet region 112 has a semi-arc shape, and is smoothly connected to each of the inner wall surfaces 115Is of the two adjacent introduction regions 113 in the cross section, at the connection position 114.

When the curvature radius R is 0.5 times the distance La (R=0.5×La), the shape of the inlet region 112 in the B-B cross section in FIG. 26 is the same as the shape shown in FIG. 28. That is, when the curvature radius R is 0.5 times the distance La (R=0.5×La), the upstream-side end portion 111 in the B-B cross section in FIG. 26 is formed by the flat surface 112p.

When the curvature radius R is 0.5 times the distance La (R=0.5×La), the shape of the inlet region 112 in the A-A cross section in FIG. 26 is the same as the shape shown in FIG. 27, and the inlet region 112 is formed by the inner wall surface 112Is having a curve of the curvature radius R in the cross section taken along the direction of the axis line O, except for the flat surface 112p. Therefore, when the air flows into the inlet region 112, the air is easily guided into the inlet region 112. Therefore, the air is less likely to be separated from the inner peripheral surfaces (inner wall surface 112Is and inner wall surface 115Is) of the inlet region 112 and the introduction region 113. In this manner, a pressure loss in the first region 101 (introduction flow path 110) can be reduced, and a flow path deviation in the first region 101 (introduction flow path 110) can be reduced. Therefore, the risk of flashback can be further effectively suppressed.

### Case of R=0.5×Lb

A case will be described where the curvature radius R is constant over the entire periphery of the inlet region 112 and is 0.5 times (R=0.5×Lb) the distance Lb.

FIG. 32A is a schematic cross-sectional view showing the A-A cross section in FIG. 26 when the curvature radius R is 0.5 times (R=0.5×Lb) the distance Lb.

FIG. 32B is a schematic cross-sectional view showing the B-B cross section in FIG. 26 when the curvature radius R is 0.5 times (R=0.5×Lb) the distance Lb.

That is, in the burner assembly 32 according to another embodiment, the inner peripheral surface (inner wall surface 112Is) of the inlet region 112 appearing in the cross section of the inlet region 112 along the direction of the axis line O in each of the inlet regions 112 may be formed in a curved shape having the curvature radius R of 0.5 times a distance Lb between the inner peripheral surfaces (inner wall surfaces 115Is) of the introduction regions 113 adjacent to each other in the third direction Dr3 extending in a direction different from the first direction Dr1 and the second direction Dr2 and orthogonal to the direction of the axis line O.

When the curvature radius R is 0.5 times the distance Lb (R=0.5×Lb), the shape of the inlet region 112 in the A-A cross section in FIG. 26 is the same as the shape shown in FIG. 29. That is, when the curvature radius R is 0.5 times the distance Lb (R=0.5×Lb), the connection portion 112c has a pointed shape in the A-A cross section in FIG. 26.

When the curvature radius R is 0.5 times the distance Lb (R=0.5×Lb), the shape of the inlet region 112 in the B-B cross section in FIG. 26 is the same as the shape shown in FIG. 27. That is, when the curvature radius R is 0.5 times the distance Lb (R=0.5×Lb), in the B-B cross section in FIG. 26, the inner wall surface 112Is that defines the inlet region 112 has a semi-arc shape, and is smoothly connected to each of the inner wall surfaces 115Is of the two adjacent introduction regions 113 in the cross section, at the connection position 114.

When the curvature radius R is 0.5 times the distance Lb (R=0.5×Lb), the shape of the inlet region 112 in the B-B cross section in FIG. 26 is the same as the shape shown in FIG. 27, and the flat surface 112p is not formed over the entire periphery of the inlet region 112. Therefore, when the air flows into the inlet region 112, the air is easily guided into the inlet region 112. Therefore, the air is less likely to be separated from the inner peripheral surfaces (inner wall surface 112Is and inner wall surface 115Is) of the inlet region 112 and the introduction region 113.

In particular, in the B-B cross section in FIG. 26 in which the distance L between the inner wall surfaces 115Is of the two adjacent introduction regions 113 is the longest, the shape of the inlet region 112 is the same as the shape shown in FIG. 27. Therefore, the air is more easily guided into the inlet region 112 when the air flows into the inlet region 112. In this manner, a pressure loss in the first region 101 (introduction flow path 110) can be reduced, and a flow path deviation in the first region 101 (introduction flow path 110) can be reduced. Therefore, the risk of flashback can be further effectively suppressed.

### Case of R>0.5×Lb

A case will be described where the curvature radius R is constant over the entire periphery of the inlet region 112 and exceeds 0.5 times the distance Lb (R>0.5×Lb).

FIG. 33A is a schematic cross-sectional view showing the A-A cross section in FIG. 26 when the curvature radius R exceeds 0.5 times the distance Lb (R>0.5×Lb).

FIG. 33B is a schematic cross-sectional view showing the B-B cross section in FIG. 26 when the curvature radius R exceeds 0.5 times the distance Lb (R>0.5×Lb).

That is, in the burner assembly 32 according to another embodiment, in each of the inlet regions 112, the inner peripheral surface (inner wall surface 112Is) of the inlet region 112 appearing in the cross section of the inlet region 112 along the direction of the axis line O may be formed in a curved shape having the curvature radius R exceeding 0.5 times the distance Lb between the inner peripheral surfaces (inner wall surfaces 115Is) of the introduction regions 113 adjacent to each other in the third direction Dr3 extending in a direction different from the first direction Dr1 and the second direction Dr2 and orthogonal to the direction of the axis line O.

When the curvature radius R exceeds 0.5 times the distance Lb (R>0.5×Lb), the shape of the inlet region 112 is the same as the shape shown in FIG. 29 in both the A-A cross section in FIG. 26 and the B-B cross section in FIG. 26. That is, when the curvature radius R exceeds 0.5 times the distance Lb (R>0.5×Lb), the connection portion 112c has a pointed shape in both the A-A cross section in FIG. 26 and the B-B cross section in FIG. 26. That is, when the curvature radius R exceeds 0.5 times the distance Lb (R>0.5×Lb), the inlet region 112 is surrounded by the connection portion 112c having a pointed shape over the entire periphery. Therefore, when the curvature radius R exceeds 0.5 times the distance Lb (R>0.5×Lb), the flat surface 112p is not formed.

When the curvature radius R exceeds 0.5 times the distance Lb (R>0.5×Lb), the flat surface 112p is not formed over the entire periphery of the inlet region 112. Therefore, when the air flows into the inlet region 112, the air is easily guided into the inlet region 112. Therefore, the air is less likely to be separated from the inner peripheral surfaces (inner wall surface 112Is and inner wall surface 115Is) of the inlet region 112 and the introduction region 113.

### Case of Avoiding Formation of Flat Surface 112p and Connection Portion 112c Having Pointed Shape Over Entire Periphery of Inlet Region 112

A case of avoiding formation of the flat surface 112p and the connection portion 112c having a pointed shape over the entire periphery of the inlet region 112, that is, a case where the shape of the inlet region 112 is the same as the shape shown in FIG. 27 over the entire periphery of the inlet region 112 will be described.

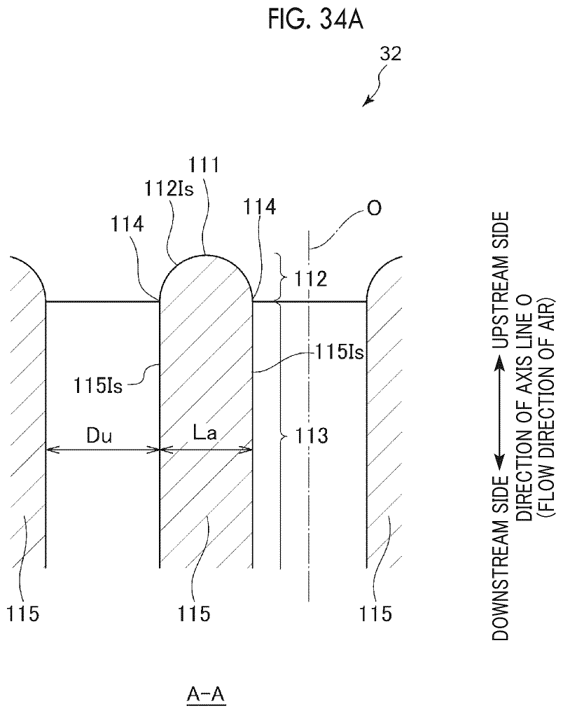

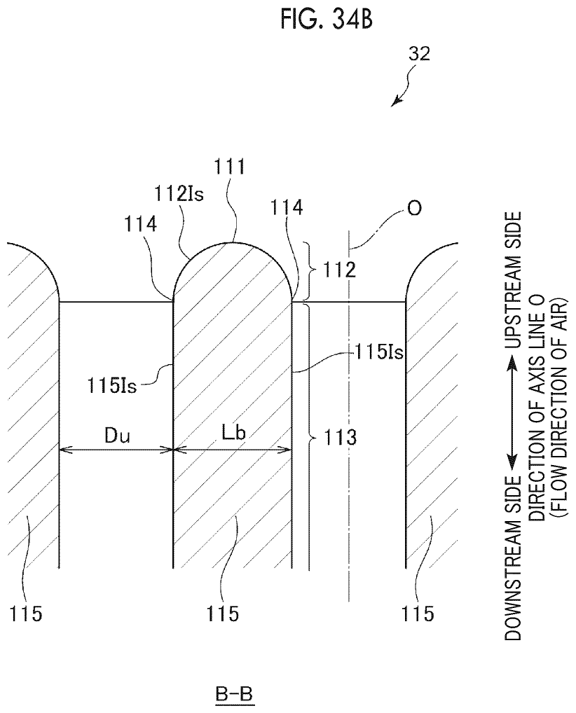

FIG. 34A is a schematic cross-sectional view showing the A-A cross section in FIG. 26 in a case of avoiding the formation of the flat surface 112p and the connection portion 112c having the pointed shape over the entire periphery of the inlet region 112.

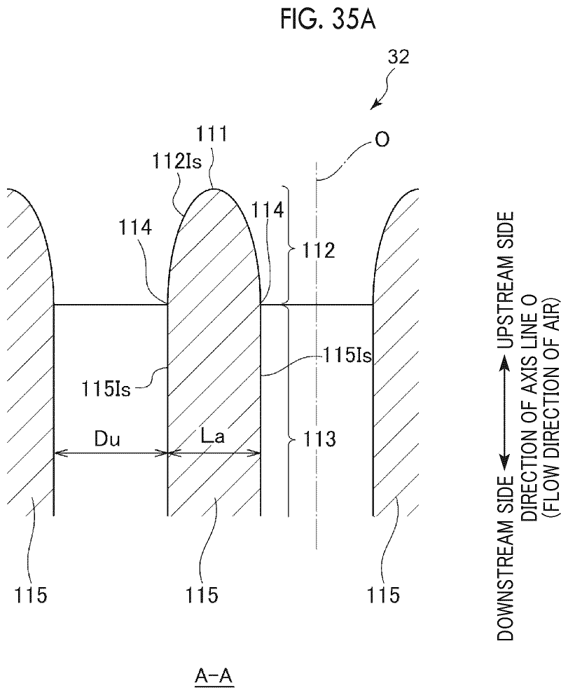

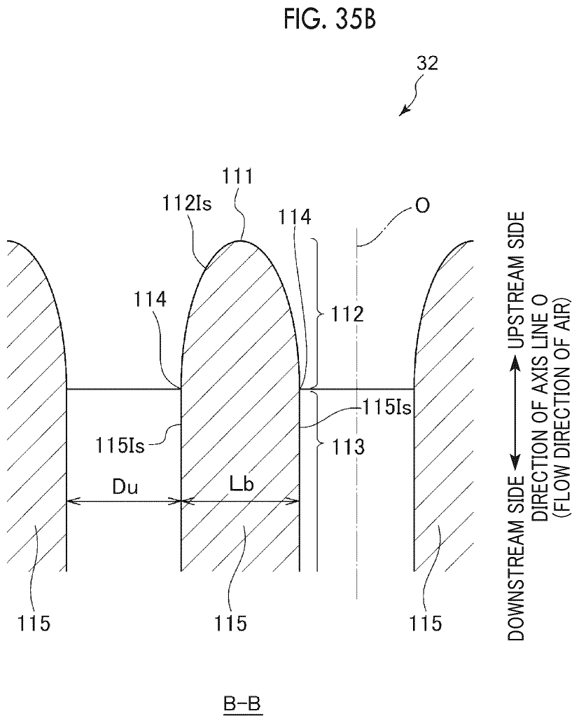

FIG. 35B is a schematic cross-sectional view showing the B-B cross section in FIG. 26 in a case of avoiding the formation of the flat surface 112p and the connection portion 112c having the pointed shape over the entire periphery of the inlet region 112.

In order to avoid the formation of the flat surface 112p and the connection portion 112c having the pointed shape over the entire periphery of the inlet region 112, in both the cross sections including the central axis line O, the curvature radius R may be set to be 0.5 times the distance L (R=0.5×L) between the inner wall surfaces 115Is of the adjacent introduction regions 113 in the cross section, that is, to establish a relationship of R=0.5×L over the entire periphery.

In each of the embodiments described with reference to FIGS. 30A to 34B, the inner wall surface 112Is of the inlet region 112 appearing in the cross section including the central axis line O has the curvature radius R which is constant from the connection position 114 to the upstream-side end portion 111. However, the curvature radius R may be changed from the connection position 114 to the upstream-side end portion 111.

FIG. 35A is a schematic cross-sectional view showing the A-A cross section in FIG. 26 when the shape of the inner wall surface 112Is of the inlet region 112 appearing in the cross section including the central axis line O over the entire periphery of the inlet region 112 is an elliptical shape having a major axis parallel to the direction of the axis line O.

FIG. 35B is a schematic cross-sectional view showing the B-B cross section in FIG. 26 when the shape of the inner wall surface 112Is of the inlet region 112 appearing in the cross section including the central axis line O over the entire periphery of the inlet region 112 is the elliptical shape having the major axis parallel to the direction of the axis line O.

As shown in FIGS. 35A and 35B, for example, the shape of the inner wall surface 112Is of the inlet region 112 appearing in the cross section including the central axis line O over the entire periphery of the inlet region 112 may be the elliptical shape having the major axis parallel to the direction of the axis line O.

As shown in FIGS. 35A and 35B, when the shape of the inner wall surface 112Is of the inlet region 112 appearing in the cross section including the central axis line O is the elliptical shape having the major axis parallel to the direction of the axis line O, a major axis radius may be equal to or larger than 3 times the distance L.

In each of the embodiments described with reference to FIGS. 26 to 34B, the first direction Dr1 and the second direction are orthogonal to each other, but the first direction Dr1 and the second direction do not need to be necessarily orthogonal to each other.

The present disclosure is not limited to the above-described embodiments, and also includes a form in which modifications are added to the above-described embodiments or a form in which the embodiments are combined with each other as appropriate.

For example, in the above-described embodiment, each of the burners 42 includes one introduction flow path 110, one mixing flow path 46, and four fuel nozzles 43 disposed around the one mixing flow path 46, and is configured such that the fuel is injected from the four fuel nozzles 43 around the one mixing flow path 46. However, each of the burners 42 may have only one fuel nozzle 43, and may have at least one fuel nozzle 43.

For example, contents described in each of the above-described embodiments are understood as follows.
(1) The burner assembly 32 according to at least one embodiment of the present disclosure is the burner assembly 32 including the plurality of burners 42 for mixing the fuel and the air. Each of the plurality of burners 42 includes the flow path 100 through which the air can flow. The flow path 100 includes the first region 101 (introduction flow path 110) that is the region on the upstream side of the flow of the air and in which the injection hole of the fuel (fuel injection hole 53) is formed, and the second region 102 (mixing flow path 46) that is the downstream-side region of the first region 101 (introduction flow path 110) and in which the fuel injected from the injection hole (fuel injection hole 53) and the air are mixed. The first region 101 (introduction flow path 110) extends from the upstream-side end portion 111 of the flow path 100 to the connection position (inlet 48) with the second region 102 (mixing flow path 46). The first region 101 (introduction flow path 110) has the injection hole (fuel injection hole 53) formed at the position closer to the connection position (inlet 48) than the upstream-side end portion 111. The first region 101 (introduction flow path 110) includes at least one protrusion portion 51 protruding inward in the radial direction of the flow path 100 and having the injection hole (fuel injection hole 53), and at least one peripheral wall portion 116 adjacent to the at least one protrusion portion 51 in the circumferential direction of the flow path 100 and in which the protrusion portion 51 is not provided. In a cross-sectional area of the flow path 100 when viewed in the extending direction of the flow path 100, the second cross-sectional area S2 in the second region 102 (mixing flow path 46) is smaller than the first cross-sectional area S1 in the first region 101 (introduction flow path 110).

According to the configuration of (1) described above, when the air flows into the second region 102 (mixing flow path 46) from the first region 101 (introduction flow path 110), the cross-sectional area of the flow path 100 when viewed in the extending direction of the flow path 100 is reduced. Therefore, the air flowing into the second region 102 (mixing flow path 46) from the first region 101 (introduction flow path 110) flows inward in the radial direction in the vicinity of the connection position (inlet 48). In this manner, a region having the high fuel concentration is less likely to be formed in the vicinity of the inner wall (wall surface 55s) of the second region 102 (mixing flow path 46). As a result, it is possible to suppress a risk of flashback, which is backfire from the outlet 47 of the second region 102 (mixing flow path 46).

In addition, according to the configuration of (1) described above, the injection hole of the fuel (fuel injection hole 53) is formed at the position closer to the connection position (inlet 48) than the upstream-side end portion 111 in the first region 101 (introduction flow path 110). In this manner, even when the air with a disturbed flow flows into the first region 101 (introduction flow path 110), the air is rectified in a process of reaching the vicinity of the injection hole (fuel injection hole 53) (vicinity of the fuel injection flow) in the first region 101 (introduction flow path 110). Therefore, influence of the turbulence of the flow of the air before flowing into the first region 101 (introduction flow path 110) is suppressed, and a region having the low flow velocity and the high fuel concentration is less likely to be formed in the vicinity of the injection hole (fuel injection hole 53) (vicinity of the fuel injection flow). As a result, a risk of flashback can be suppressed.
(2) In some embodiments, in the configuration of (1) described above, the first distance L1 in the extending direction between the upstream-side end portion 111 of the flow path 100 and the center position of the opening 53ap in the protrusion portion 51 of the injection hole (fuel injection hole 53) may be equal to or larger than 1 time the corresponding diameter (inner diameter Dm) of the second region 102 (mixing flow path 46) when viewed in the extending direction.

According to the configuration of (2) described above, since the air can be effectively rectified in the first region 101 (introduction flow path 110), the risk of flashback can be effectively suppressed.
(3) In some embodiments, in the configuration of (2) described above, the first distance L1 may be equal to or larger than 5 times the corresponding diameter (inner diameter Dm).

According to the configuration of (3) described above, since the air can be more effectively rectified in the first region 101 (introduction flow path 110), the risk of flashback can be more effectively suppressed.
(4) In some embodiments, in any of the configurations of (1) to (3) described above, the protrusion portion 51 may include the linear portion (base end portion 431) extending in a linear shape along the extending direction in the cross section taken along the extending direction, and the tip portion 432 formed such that the inward protruding amount in the radial direction gradually increases toward the linear portion (base end portion 431) on the upstream side of the linear portion (base end portion 431).

According to the configuration of (4) described above, since the tip portion 432 is formed such that the inward protruding amount in the radial direction gradually increases toward the linear portion(base end portion 431) on the upstream side of the linear portion(base end portion 431), the separation of the air flow from the tip portion 432 toward the linear portion (base end portion 431) can be suppressed. Therefore, a region having the low flow velocity and the high fuel concentration is less likely to be formed in the vicinity of the injection hole (fuel injection hole 53) (vicinity of the fuel injection flow). As a result, a risk of flashback can be suppressed.
(5) In some embodiments, in the configuration of (4) described above, the second distance L2 in the extending direction between the connection position (inlet 48) and the upstream-side end portion 44u in the linear portion (base end portion 431) may be equal to or smaller than 1 time the corresponding diameter (inner diameter Dm) of the second region 102 (mixing flow path 46) when viewed in the extending direction.

According to the configuration of (5) described above, formation of a low velocity region can be suppressed in the vicinity of the wall surface of the flow path 100 by suppressing an increase in the length of the protrusion portion 51 along the extending direction.
(6) In some embodiments, in the configuration of (4) or (5) described above, the third distance L3 in the extending direction between the connection position (inlet 48) and the center position of the opening 53ap in the protrusion portion 51 of the injection hole (fuel injection hole 53) may be larger than the opening diameter dap of the opening 53ap, and may be smaller than the second distance L2 in the extending direction between the connection position (inlet 48) and the upstream-side end portion 44u in the linear portion (base end portion 431).

According to the configuration of (6) described above, since the fuel ejected from the injection hole (fuel injection hole 53) is less likely to form a region having the high fuel concentration in the vicinity of the inner wall of the first region 101 (introduction flow path 110) or the second region 102 (mixing flow path 46), the risk of flashback can be suppressed.
(7) In some embodiments, in any of the configurations of (4) to (6) described above, the surface (top surface 54) of the tip portion 432 may have the arc shape in the cross section taken along the extending direction.

According to the configuration of (7) described above, while the distance from the upstream-side end portion 111 of the flow path 100 to the linear portion (base end portion 431) can be suppressed, a configuration can be adopted such that the flow of the air is less likely to be disturbed from the tip portion 432 to the linear portion (base end portion 431). Therefore, it is easy to ensure the advantageous effect of the present disclosure in which the region having the high fuel concentration is less likely to be formed in the vicinity of the inner wall (wall surface 55s) of the second region 102 (mixing flow path 46).
(8) In some embodiments, in any of the configurations of (4) to (6) described above, the surface (top surface 54) of the tip portion 432 may have the elliptical arc shape in the cross section taken along the extending direction.

According to the configuration of (8) described above, for example, when the major axis of the elliptical arc extends along the extending direction of the flow path 100, compared to a case where the surface (top surface 54) of the tip portion 432 has the arc shape in the cross section taken along the extending direction, a configuration can be adopted such that the flow of the air is less likely to be disturbed from the tip portion 432 to the linear portion (base end portion 431). Therefore, it is easy to ensure the advantageous effect of the present disclosure in which the region having the high fuel concentration is less likely to be formed in the vicinity of the inner wall (wall surface 55s) of the second region 102 (mixing flow path 46).

In addition, for example, when the minor axis of the elliptical arc extends along the extending direction of the flow path 100, compared to a case where the surface (top surface 54) of the tip portion 432 has the arc shape in the cross section taken along the extending direction, the distance from the upstream-side end portion 111 of the flow path 100 to the linear portion (base end portion 431) can be suppressed, and an increase in the total length of the flow path 100 can be suppressed.
(9) In some embodiments, in any of the configurations of (4) to (8) described above, a fourth distance LA in the extending direction between the upstream-side end portion 111 of the flow path 100 and an upstream-side end portion 51t of the protrusion portion 51 may be equal to or larger than 0.

According to the configuration of (9) described above, the risk of flashback can be suppressed while a rectifying effect of the air in the first region 101 (introduction flow path 110) can be ensured.
(10) In some embodiments, in any of the configurations of (1) to (9) described above, the first region 101 (introduction flow path 110) may include the inlet region 112 including the upstream-side end portion 111 and the introduction region 113 connected to the inlet region 112 on the downstream side of the inlet region 112. The inlet region 112 may be defined by the inner wall surface (inner wall surface 112Is) formed in a curved shape convex inward of the first region 101 (introduction flow path 110) in the cross section taken along the extending direction (direction of the axis line O), and may be formed such that the cross-sectional area of the flow path 100 gradually decreases toward the downstream side. The introduction region 113 may be defined by the inner wall surface (inner wall surface 115Is) formed in a linear shape parallel to the extending direction (direction of the axis line O) in the cross section taken along the extending direction (direction of the axis line O).

According to the configuration of (10) described above, when the air flows into the inlet region 112, the air is easily guided into the inlet region 112. Therefore, the air is less likely to be separated from the inner peripheral surfaces (inner wall surface 112Is and inner wall surface 115Is) of the inlet region 112 and the introduction region 113. In this manner, a pressure loss in the first region 101 (introduction flow path 110) can be reduced, and a flow path deviation in the first region 101 (introduction flow path 110) can be reduced. Therefore, the risk of flashback can be further effectively suppressed.
(11) In some embodiments, in the configuration of (10) described above, the plurality of flow paths 100 may be disposed at an equal interval along the first direction Dr1 orthogonal to the extending direction (direction of the axis line O) and the second direction Dr2 orthogonal to the extending direction (direction of the axis line O) and the first direction Dr1. In each of the inlet regions 112, the inner peripheral surface (inner wall surface 112Is) of the inlet region 112 appearing in the cross section of the inlet region 112 along the extending direction (direction of the axis line O) may be formed in a curved shape having the curvature radius R of 0.5 times the distance La between the inner peripheral surfaces (inner wall surfaces 115Is) of the adjacent introduction regions 113 in the first direction Dr1.

According to the configuration of (11) described above, when the air flows into the inlet region 112, the air is easily guided into the inlet region 112. Therefore, the air is less likely to be separated from the inner peripheral surfaces (inner wall surface 112Is and inner wall surface 115Is) of the inlet region 112 and the introduction region 113. In this manner, a pressure loss in the first region 101 (introduction flow path 110) can be reduced, and a flow path deviation in the first region 101 (introduction flow path 110) can be reduced. Therefore, the risk of flashback can be further effectively suppressed.
(12) In some embodiments, in the configuration of (10) described above, the plurality of flow paths 100 may be disposed at an equal interval along the first direction Dr1 orthogonal to the extending direction (direction of the axis line O) and the second direction Dr2 orthogonal to the extending direction (direction of the axis line O) and the first direction Dr1. In each of the inlet regions 112, the inner peripheral surface (inner wall surface 112Is) of the inlet region 112 appearing in the cross section of the inlet region 112 along the extending direction (direction of the axis line O) may be formed in a curved shape having the curvature radius R of 0.5 times the distance Lb between the inner peripheral surfaces (inner wall surfaces 115Is) of the introduction regions 113 adjacent to each other in the third direction Dr3 extending in a direction different from the first direction Dr1 and the second direction Dr2 and orthogonal to the extending direction (direction of the axis line O).

According to the configuration of (12) described above, when the air flows into the inlet region 112, the air is easily guided into the inlet region 112. Therefore, the air is less likely to be separated from the inner peripheral surfaces (inner wall surface 112Is and inner wall surface 115Is) of the inlet region 112 and the introduction region 113. In this manner, a pressure loss in the first region 101 (introduction flow path 110) can be reduced, and a flow path deviation in the first region 101 (introduction flow path 110) can be reduced. Therefore, the risk of flashback can be further effectively suppressed.
(13) In some embodiments, in the configuration of (10) described above, the plurality of flow paths 100 may be disposed at an equal interval along the first direction Dr1 orthogonal to the extending direction (direction of the axis line O) and the second direction Dr2 orthogonal to the extending direction (direction of the axis line O) and the first direction Dr1. In each of the inlet regions 112, the inner peripheral surface (inner wall surface 112Is) of the inlet region 112 appearing in the cross section of the inlet region 112 along the extending direction (direction of the axis line O) may be formed in a curved shape having the curvature radius R exceeding 0.5 times the distance Lb between the inner peripheral surfaces (inner wall surfaces 115Is) of the adjacent introduction regions 113 in the third direction Dr3 extending in a direction different from the first direction Dr1 and the second direction Dr2 and orthogonal to the extending direction (direction of the axis line O).

According to the configuration of (13) described above, when the air flows into the inlet region 112, the air is easily guided into the inlet region 112. Therefore, the air is less likely to be separated from the inner peripheral surfaces (inner wall surface 112Is and inner wall surface 115Is) of the inlet region 112 and the introduction region 113. In this manner, a pressure loss in the first region 101 (introduction flow path 110) can be reduced, and a flow path deviation in the first region 101 (introduction flow path 110) can be reduced. Therefore, the risk of flashback can be further effectively suppressed.
(14) In some embodiments, in any of the configurations of (1) to (9) described above, the flow path 100 may include the first flow path 100a and the second flow path 100b closest to the first flow path 100a. The upstream-side end portion 51t of the protrusion portion 51 may be located on the downstream side of the upstream-side end portion 111 of the flow path 100. The diameter (inner diameter Du) when at least a portion of the region on the upstream side of the upstream-side end portion 51t of the protrusion portion 51 is viewed in the extending direction, inside the first region 101 (introduction flow path 110) may be equal to a value (Du=P−2×t1) obtained by subtracting twice the thickness t1 of the bulkhead (bulkhead portion 118 (118ab)) that separates the first region 101 (introduction flow path 110 (110a)) in the first flow path 100a and the first region 101 (introduction flow path 110 (110b)) in the second flow path 100b from the separation distance P between the central axis (central axis line O) of the first region 101 (introduction flow path 110 (110a)) in the first flow path 100a along the extending direction and the central axis (central axis line O) of the first region 101 (introduction flow path 110 (110b)) in the second flow path 100b along the extending direction.

According to the configuration of (14) described above, the inner diameter Du of the introduction flow path 110 can be adjusted by appropriately adjusting the thickness t1 of the bulkhead (bulkhead portion 118 (118ab)) that separates the introduction flow path 110 (110a) in the first flow path 100a and the introduction flow path 110 (110b) in the second flow path 100b.
(15) The gas turbine combustor (combustor 4) according to at least one embodiment of the present disclosure includes the burner assembly 32 having any of the configurations of (1) to (14) described above, and the combustion cylinder 25 forming a space in which a flame is formed on the downstream side of the burner assembly 32.

According to the configuration of (15) described above, since the burner assembly 32 of any one of the configurations of (1) to (14) described above is provided, the risk of flashback can be suppressed. Therefore, the gas turbine combustor (combustor 4) can be stably used.
(16) The gas turbine 1 according to at least one embodiment of the present disclosure includes the compressor 2, the gas turbine combustor (combustor 4) to which the air compressed by the compressor 2 and the fuel are supplied, and configured to generate the combustion gas by combusting the fuel, and the turbine 6 driven by the combustion gas generated in the gas turbine combustor (combustor 4). The gas turbine combustor (combustor 4) is the gas turbine combustor (combustor 4) having the configuration of (15) described above.

According to the configuration of (16), since the gas turbine combustor (combustor 4) having the configuration of (15) is provided, the risk of flashback can be suppressed, and the gas turbine 1 can be stably operated.

### REFERENCE SIGNS LIST

1: gas turbine
2: compressor
4: combustor (gas turbine combustor)
6: turbine
25: combustion cylinder
32: burner assembly
42: burner
42a: first burner
42b: second burner
43: fuel nozzle
44: side surface
44u: end portion
46: mixing flow path
47: outlet
48: inlet
50: protrusion portion
51: protrusion portion
51t: end portion
53: fuel injection hole
53ap: opening
54: top surface
55: flow path wall
55s: wall surface
58: bulkhead portion
61: end portion
100: flow path
100a: first flow path
100b: second flow path
101: first region
102: second region
110: introduction flow path
111: upstream-side end portion
112: inlet region
113: introduction region
115: introduction flow path wall
116: peripheral wall portion
118: bulkhead portion
431: base end portion
432: tip portion

1. A burner assembly comprising:
a plurality of burners for mixing a fuel and air,
wherein each of the plurality of burners includes a flow path through which the air is configured to flow,
the flow path includes
a first region that is a region on an upstream side of a flow of the air and having an injection hole of the fuel, and
a second region that is a downstream-side region of the first region and in which the fuel injected from the injection hole and the air are mixed,
the first region extends from an upstream-side end portion of the flow path to a connection position to the second region,
the first region has the injection hole formed at a position closer to the connection position than the upstream-side end portion,
the first region includes
at least one protrusion portion protruding inward of the flow path in a radial direction and having the injection hole, and
at least one peripheral wall portion adjacent to the at least one protrusion portion in a circumferential direction of the flow path and in which the protrusion portion is not provided, and
in a cross-sectional area of the flow path when viewed in an extending direction of the flow path, a second cross-sectional area in the second region is smaller than a first cross-sectional area in the first region.

2. The burner assembly according to claim 1,
wherein a first distance in the extending direction between the upstream-side end portion of the flow path and a center position of an opening of the injection hole in the protrusion portions is equal to or larger than 1 time a corresponding diameter of the second region when viewed in the extending direction.

3. The burner assembly according to claim 2,
wherein the first distance is equal to or larger than 5 times the corresponding diameter.

4. The burner assembly according to claim 1,
wherein the protrusion portion includes
a linear portion extending in a linear shape along the extending direction in a cross section taken along the extending direction, and
a tip portion formed such that an inward protruding amount in the radial direction gradually increases toward linear portion on the upstream side of the linear portion.

5. The burner assembly according to claim 4,
wherein a second distance in the extending direction between the connection position and the upstream-side end portion in the linear portion is equal to or smaller than 1 time a corresponding diameter of the second region when viewed in the extending direction.

6. The burner assembly according to claim 4,
wherein a third distance in the extending direction between the connection position and a center position of an opening of the injection hole in the protrusion portion is larger than an opening diameter of the opening, and is smaller than a second distance in the extending direction between the connection position and an upstream-side end portion in the linear portion.

7. The burner assembly according to claim 4,
wherein a surface of the tip portion has an arc shape in the cross section taken along the extending direction.

8. The burner assembly according to claim 4,
wherein a surface of the tip portion has an elliptical arc shape in the cross section taken along the extending direction.

9. The burner assembly according to claim 4,
wherein a fourth distance in the extending direction between the upstream-side end portion of the flow path and an upstream-side end portion of the protrusion portion is equal to or larger than 0.

10. The burner assembly according to claim 1,
wherein the first region includes
an inlet region including the upstream-side end portion, and
an introduction region connected to the inlet region on a downstream side of the inlet region,
the inlet region is defined by an inner wall surface formed in a curved shape convex inward of the first region in a cross section taken along the extending direction, and is formed such that a cross-sectional area of the flow path gradually decreases toward the downstream side, and
the introduction region is defined by an inner wall surface formed in a linear shape parallel to the extending direction in the cross section taken along the extending direction.

11. The burner assembly according to claim 10,
wherein a plurality of the flow paths are disposed at an equal interval in a first direction orthogonal to the extending direction and in a second direction orthogonal to the extending direction and the first direction, and
in each of the inlet regions, an inner peripheral surface of the inlet region, which appears in a cross section of the inlet region along the extending direction, is formed in a curved shape having a curvature radius of 0.5 times a distance between inner peripheral surfaces of the introduction regions adjacent to each other in the first direction.

12. The burner assembly according to claim 10,
wherein a plurality of the flow paths are disposed at an equal interval in a first direction orthogonal to the extending direction and in a second direction orthogonal to the extending direction and the first direction, and
in each of the inlet regions, an inner peripheral surface of the inlet region, which appears in a cross section of the inlet region along the extending direction, extends in a direction different from the first direction and the second direction, and is formed in a curved shape having a curvature radius of 0.5 times a distance between the inner peripheral surfaces of the introduction regions adjacent to each other in a third direction orthogonal to the extending direction.

13. The burner assembly according to claim 10,
wherein a plurality the flow paths are disposed at an equal interval in a first direction orthogonal to the extending direction and in a second direction orthogonal to the extending direction and the first direction, and
in each of the inlet regions, an inner peripheral surface of the inlet region, which appears in a cross section of the inlet region along the extending direction, extends in a direction different from the first direction and the second direction, and is formed in a curved shape having a curvature radius exceeding 0.5 times a distance between the inner peripheral surfaces of the introduction regions adjacent to each other in a third direction orthogonal to the extending direction.

14. The burner assembly according to claim 1,
wherein the flow path includes a first flow path and a second flow path closest to the first flow path,
an upstream-side end portion of the protrusion portion is located on the downstream side of the upstream-side end portion of the flow path, and
a diameter of at least a portion of a region on the upstream side of the upstream-side end portion of the protrusion portion inside the first region when viewed in the extending direction is equal to a value obtained by subtracting twice a thickness of a bulkhead that separates the first region in the first flow path and the first region in the second flow path from a separation distance between a central axis along the extending direction of the first region in the first flow path and a central axis along the extending direction of the first region in the second flow path.

15. A gas turbine combustor comprising:
the burner assembly according to claim 1; and
a combustion cylinder forming a space in which a flame is formed on a downstream side of the burner assembly.

16. A gas turbine comprising:
a compressor;
a gas turbine combustor to which air compressed by the compressor and a fuel are supplied, and configured to generate a combustion gas by combusting the fuel; and
a turbine driven by the combustion gas generated in the gas turbine combustor,
wherein the gas turbine combustor is the gas turbine combustor according to claim 15.
